(19) United States
(12) Patent Application Publication
(10) Pub. No.: US 2025/0131418 A1
(43) Pub. Date: Apr. 24, 2025

(54) SECURING ELECTRONIC TRANSFERS BY PERFORMING PRE-TRANSACTION VERIFICATION AND AUTHENTICATION

(71) Applicant: RSF Investments LLC, Weatherford, TX (US)

(72) Inventors: Christopher Salvador, Weatherford, TX (US); Daniel Salvador, Weatherford, TX (US); Kapil Saxena, Ghaziabad (IN); Alankar Bhatnagar, Noida (IN); Ishu Chawla, New Delhi (IN); Pavan Kumar, Kakinada (IN); Anushka Jindal

(73) Assignee: RSF Investments LLC, Weatherford, TX (US)

(21) Appl. No.: 18/492,353

(22) Filed: Oct. 23, 2023

(51) Int. Cl. G06Q 20/38; G06Q 20/02; G06Q 20/22; G06Q 20/32; G06Q 20/36

(52) U.S. Cl. CPC G06Q 20/3821; G06Q 20/023; G06Q 20/223; G06Q 20/3223; G06Q 20/3255; G06Q 20/36

(57) ABSTRACT

Systems and methods for proactive and automated pre-transaction verification and authentication of electronic transfers are described. In various examples, transaction details associated with an electronic transfer (e.g., a wire transfer, an Automated Clearing House (ACH) transfer, a peer-to-peer (P2P) transfer, or a cryptocurrency transfer) are verified and the recipient is authenticated by a transaction verification service associated with an electronic transfer service provider (e.g., a financial institution, a peer-to-peer (P2P) payment system, or a custodial wallet provider) prior to permitting the electronic transfer to proceed. In this manner, electronic transfers are secured against electronic transfer fraud and/or mistaken fund or asset transfers, for example, to an incorrect account (or an incorrect cryptocurrency wallet) by the electronic transfer service provider.

### TECHNICAL FIELD

Embodiments described herein generally relate to the field of electronic transfers (e.g., wire transfers, Automated Clearing House (ACH) transfers, peer-to-peer (P2P) transfers, and cryptocurrency transfers) and, more particularly, to securing such electronic transfers to avoid electronic transfer fraud and/or mistaken fund or asset transfers, for example, to an incorrect account (or digital wallet) of an electronic transfer service provider (e.g., a financial institution, a peer-to-peer payment system, or a cryptocurrency wallet provider) by performing a pre-transaction verification and authentication process, for example, to verify all or some subset of the transaction details of a prospective electronic transfer and authenticate a recipient (or payee) of the electronic transfer prior to permitting the electronic transfer to proceed.

### BACKGROUND

Funds (e.g., a sum of money) and (intangible) assets (e.g., cryptocurrency) may be transferred between accounts (or digital wallets) of individuals (e.g., a sender or payor and a recipient or payee) electronically. Examples of electronic transfers include wire transfers, Automated Clearing House (ACH) transfers, peer-to-peer (or party-to-party) (P2P) transfers (e.g., fund transfers initiated via P2P payment systems, such as Zelle, Venmo, PayPal, Cash App, etc.), and cryptocurrency transfers.

A wire transfer (also known as a wire payment) is an electronic transfer of funds via one of a number of wire network that are administered by financial institutions (e.g., banks and credit unions) and transfer service agencies around the world. U.S. dollar payments may be electronically settled by member institutions (e.g., Federal Reserve banks) via a real-time gross settlement system referred to as the Fedwire Funds Service (or simply, Fedwire). The Federal Reserve also operates another payment system referred to as the National Settlement Service. Most international money and security transfers are performed via the Society for Worldwide Interbank Financial Telecommunications (SWIFT) system.

While these payment systems are generally considered secure between a given originating (or source) financial institution and a given receiving (or destination) financial institution once a transaction is initiated, if funds are transferred to the wrong account, for example, as a result of fraudulent statements or representations of the recipient of the wire transfer or due to a mistake made by or on behalf of the sender of the wire transfer, it is more likely than not the associated funds will not be recoverable by the sender. There are a number of wire transfer scams in which a scammer poses as an Internal Revenue Service (IRS) representative, a relative or a friend of a target individual, a vendor of the target individual, or a vendor of a business entity with which the target individual is associated. Scammers may also sometimes send a fake check (e.g., a cashier's check, personal check, money order, etc.) and ask the target individual to cash it and then send them the money via a wire transfer. There may be a very limited time (e.g., sometimes around 30 minutes) during which an international remittance may be cancelled; however, generally once the receiving financial institution has accepted a wire transfer, it cannot be reversed, cancelled, or returned. As such, great care must be taken before wiring payments and when filling out wire transfer forms when performing an in-branch wire transfer or using a banking application to perform a wire transfer. Advice by state attorneys general is typically along the lines of “If you don't know the person you're sending the money to—or if you haven't known them very long—simply don't do it.” Such advice is often impractical as one is generally not familiar with many individuals or companies to whom they may need to make a one-off electronic transfer funds, for example, to make a down payment and/or remit closing costs in connection with the purchase of a property or a large institutional settlement transaction.

Similar potential for loss due to fraud or mistake exist for electronic transfers more generally, including ACH transfers, P2P transfers, and cryptocurrency transfers (due to the irreversible nature of cryptocurrency protocols).

### SUMMARY

Systems and methods are described for securing electronic transfers by performing pre-transaction verification and/or authentication. According to one embodiment, a request to initiate a transfer of funds from an account of a sender maintained at a first financial institution to an account of a recipient maintained at a second financial institution is received by the first financial institution. Transaction details, including an amount of funds to be transferred from the account of the sender to the account of the recipient, a financial institution identifier of the second financial institution, and an account number of the account of the recipient, are received by or on behalf of the sender. Thereafter, the transaction details are verified and the recipient is authenticated by: (i) receiving, by or on behalf of the sender, at a web portal (i) an electronic address through which the recipient may receive electronic communications and (ii) a shared secret in possession of both the sender and the recipient; (ii) causing an electronic communication, including a link to a recipient verification portal, to be sent to the recipient via the electronic address; (iii) responsive to the recipient navigating to the recipient verification portal, causing the recipient to be prompted for the transaction details and the shared secret; (iv) determining a verification and authentication result by comparing (a) the transaction details received by or on behalf of the sender to the transaction details received from the recipient and (b) the shared secret received by or on behalf of the sender to the shared secret received from the recipient; and (v) only after an affirmative verification and authentication result has been determined, permitting the transfer to proceed.

Other features of embodiments of the present disclosure will be apparent from accompanying drawings and detailed description that follows.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is a high-level block diagram illustrating a transaction verification service implemented within a financial institution private cloud in accordance with an embodiment of the present disclosure.

FIG. 2 is a block diagram illustrating an example of a wire transfer service in accordance with an embodiment of the present disclosure.

FIG. 3 is a block diagram illustrating an example of a transaction verification service in accordance with an embodiment of the present disclosure.

FIGS. 4A-E are example screen shots of a mobile or desktop financial application for collecting transaction details relating to a wire transfer in accordance with an embodiment of the present disclosure.

FIG. 5 is a flow diagram illustrating operations for performing wire transaction pre-processing in accordance with an embodiment of the present disclosure.

FIG. 6 is a flow diagram illustrating operations for performing transaction detail verification and recipient authentication in accordance with an embodiment of the present disclosure.

FIG. 7 is a high-level block diagram illustrating a transaction verification service implemented within a financial institution private cloud in accordance with another embodiment of the present disclosure.

FIG. 8 is a high-level block diagram illustrating a transaction verification service implemented within a financial institution private cloud in accordance with yet another embodiment of the present disclosure.

FIG. 9 is a block diagram illustrating an example of an ACH or P2P transfer service in accordance with an embodiment of the present disclosure.

FIG. 10 is a block diagram illustrating an example of a payment application interface in accordance with an embodiment of the present disclosure.

FIG. 11 is a block diagram illustrating an example of interactions by a sender web portal with a sender and a recipient of a P2P transfer in accordance with an embodiment of the present disclosure.

FIGS. 12A-B are block diagrams illustrating an example of interactions with a recipient of a P2P transfer in accordance with an embodiment of the present disclosure.

FIG. 13 is a high-level block diagram illustrating a transaction verification service implemented within a custodial wallet provider private cloud in accordance with yet another embodiment of the present disclosure.

FIG. 14 is an example of a computer system with which some embodiments may be utilized.

### DETAILED DESCRIPTION

Embodiments described herein are generally directed to proactive and automated verification and authentication of transaction details associated with an electronic transfer (e.g., a wire transfer, an ACH transfer, a P2P transfer, or a cryptocurrency transfer) and the recipient, respectively, prior to permitting the electronic transfer to proceed.

As noted above, while payment networks and systems (e.g., Fedwire, the National Settlement Service, the clearing house interbank payment system (CHIPS) and SWIFT) through which wire transfers are performed are generally considered secure, fraud and/or mistake (e.g., the transposition of digits of a bank account number) may result in loss by the sender of the funds associated with a wire transfer given the very limited ability to reverse or cancel a wire transfer. Similar potential for loss due to fraud or mistake exist for electronic transfers more generally, including ACH transfers, P2P transfers, and cryptocurrency transfers.

Various embodiments described herein seek to address or at least mitigate the potential for electronic transfer fraud and electronic transfer errors. For example, as described further below, a proposed approach for pre-wire transfer verification and authentication may include a first financial institution having an account of a sender receiving a request to initiate a wire transfer of funds from the account of the sender to an account of a recipient associated with a second financial institution. Transaction details may then be received by or on behalf of the sender. The transaction details may include an amount of funds to be transferred from the account of the sender to the account of the recipient, a financial institution identifier (ID) of the second financial institution, and an account number of the recipient. The financial institution ID may be in the form of one or more of a routing number (e.g., an American bankers Association (ABA) routing number), a SWIFT code, or the like, depending on whether the wire transfer represents a domestic transfer between two US financial institutions or an international transfer in which at least the second financial institution is outside of the US.

In one embodiment, before the first financial institution sends a message initiating the wire transfer via the payment system at issue, the transaction details are verified and the recipient is authenticated. For example, a verification portal may receive by or on behalf of the sender, an electronic address through which the recipient may receive electronic communications and (ii) a shared secret in possession of both the sender and the recipient. Non-limiting examples of the shared secure include an invoice number, a personal identification number (PIN), a passphrase, a real estate title number, a phone number, a purchase order (PO) number, and a passcode. An electronic communication (including a link to the verification portal) may then be caused to be sent to the recipient via the electronic address. Responsive to the recipient following the link to the verification portal (or otherwise navigating to the verification portal), the recipient may be prompted for the transaction details and the shared secret. At this point, a verification and authentication result may be determined by comparing (i) the transaction details received by or on behalf of the sender to the transaction details received from the recipient and (ii) the shared secret received by or on behalf of the sender to the shared secret received from the recipient. In one embodiment, the wire transfer is permitted to proceed only after an affirmative verification and authentication result has been determined. If the verification and authentication fails, the wire transfer may be reinitiated and the verification and authentication performed via the verification portal may be repeated.

Similar approaches are also described herein for securing electronic transfers more generally, including ACH transfers, P2P transfers, and cryptocurrency transfers. As such, while various examples described herein may relate specifically to wire transfers, the methodologies described herein are broadly applicable to securing other types of electronic transfers, including, but not limited to electronic fund transfers via local payment routes, such as the automated clearing house (ACH) network, or cashless payments in euro currency that are processed via the single euro payments area (SEPA) network, and electronic transfers of digital currency (e.g., cryptocurrency).

While various examples described herein may be described with reference to a microservices architecture in which an application (e.g., a financial institution application, such as a wire transfer service), is implemented as a collection of loosely coupled, fine-grained services, communicating through lightweight protocols and using representational state transfer (REST) APIs, the methodologies described herein are equally applicable to other architectures (e.g., monolithic applications or applications designed in accordance with service-oriented architecture structural styles).

In the following description, numerous specific details are set forth in order to provide a thorough understanding of example embodiments. It will be apparent, however, to one skilled in the art that embodiments described herein may be practiced without some of these specific details.

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used herein, the meaning of “a,” “an,” and “the” includes plural reference unless the context clearly dictates otherwise. Also, as used in the description herein, the meaning of “in” includes “in” and “on” unless the context clearly dictates otherwise.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

As used herein a “cloud,” “cloud system,” “cloud platform,” and/or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein, a “financial institution” generally refers to a company engaged in the business of dealing with financial and monetary transactions (e.g., deposits, loans, investments, and/or currency exchange). Non-limiting examples of financial institutions include banks (e.g., central banks, retail and commercial banks, investment banks, Internet banks), credit unions, community development financial institutions, thrifts (including savings and loan associations and savings banks), brokerage firms, insurance companies, and mortgage companies.

As used herein a “financial institution identifier” or “financial institution ID” generally refers to an identifier that uniquely identifies a given financial institution or branch of a financial institution. Non-limiting examples of a financial institution ID include an American Bankers Association (ABA) routing number and a SWIFT code.

As used herein an “account number” generally refers to a set of digits and/or characters assigned to a financial account that uniquely identify an individual account within a financial institution or that uniquely identify an individual account, at a specific financial institution, in a particular country. Non-limiting examples of account numbers include International Bank Account Numbers (IBANs), US bank account numbers, which are usually a number of 8 to 17 digits for bank accounts in the US that uniquely identify a given account within a particular bank, credit union account numbers, a brokerage firm account numbers, and the like.

As used herein an “electronic fund transfer” generally refers to a transfer of funds that is initiated through an electronic terminal, telephone, and/or computer for the purpose of ordering, instructing, or authorizing a financial institution to debit or credit a consumer's account. Non-limiting examples of electronic fund transfers include wire transfers, P2P fund transfers, and ACH transfers.

As used herein a “peer-to-peer fund transfer,” or “P2P fund transfer” generally refers to an electronic fund transfer initiated via a P2P payment system (e.g., a payment system provided by Zelle, Venmo, PayPal, Cash App, and the like). P2P transfers are not technically the same as ACH transfers, but generally utilize the ACH network. A P2P transfer is basically a frontend to an ACH transfer that performs an instant ACH transfer by making use of the ACH network. P2P payment systems generally implement a thin wrapper over ACH transactions to perform instant ACH transactions based on a mapping of phone numbers and/or email addresses to corresponding account numbers of financial accounts (e.g., bank accounts). In this manner, P2P fund transfers facilitate initiation of instant ACH transactions (e.g., via mobile apps) without the sender or payor having to have knowledge of the account number of the recipient or payee and instead allow electronic fund transfers to essentially be initiated based on a phone number or an email address (that has previously been registered with the P2P payment system and associated with a particular financial account) of the recipient or payee.

As used herein a “cryptocurrency transfer” generally refers to a transfer of cryptocurrency (e.g., Bitcoin, Ethereum, and the like) from one cryptocurrency wallet (e.g., a custodial cryptocurrency wallet of a sender or payor) to another cryptocurrency wallet (e.g., a custodial or a non-custodial (or self-custody) cryptocurrency wallet of a recipient or payee).

As used herein, a “custodial wallet,” “a custodial cryptocurrency wallet,” or the like generally refers to a cryptocurrency wallet in which the wallet provider or the cryptocurrency exchange at issue holds the private keys of the wallet owner (user). A wallet provider maintaining a custodial wallet on behalf of a user generally has full control over the cryptocurrency assets and has responsibility for managing the wallet keys (e.g., private and public keys), signing transactions, and otherwise protecting the cryptocurrency assets associated with the wallet. This is in contrast to a non-custodial (or self-custody) wallet in which the private keys that represent ownership of the cryptocurrency associated with the wallet are stored directly on the end user's device (e.g., a smartphone, a laptop computer, a tablet computer, a desktop computer, etc.). In the context of various examples described herein, in order to perform pre-transaction verification processing of a cryptocurrency transaction, the cryptocurrency transaction must be initiated from a custodial wallet.

As used herein, a “wire transfer” generally refers to a credit transaction in the form of an electronic fund transfer to move funds from one financial institution to another. Wire transfers can be cancelled up until they are cleared (which can be as quick as a matter of minutes). After that, they are generally irrevocable. The term wire transfer is expressly intended not to encompass local payment routes, such as automated clearing house (ACH), or cashless payments in euro currency that are processed via the single euro payments area (SEPA) network.

As used herein, an “electronic transfer service provider” generally refers to a service provider (e.g., a financial institution, a financial services company, a P2P payment system, or a cryptocurrency wallet provider) that facilitates the transfer of funds or assets, as the case may be, from an account of one financial institution (e.g., the bank account of a sender or payor) or digital wallet of one cryptocurrency wallet provider (e.g., the cryptocurrency wallet of a sender or payor) to the same or another financial institution (e.g., the bank account of a recipient or payee) or digital wallet of the same or another cryptocurrency wallet provider (e.g., the cryptocurrency wallet of a recipient or payee). The term electronic transfer service provider is intended to encompass financial institutions, financial services companies or P2P payment systems (e.g., Zelle, Venmo, PayPal, Cash App, and the like), and custodial cryptocurrency wallet providers (e.g., Free Wallet, Binance, BitMex, Bitgo, and the like, and cryptocurrency exchanges (e.g., Coinbase, Kraken, and Crypto.com) that provide custodial wallet services).

As used herein, an “electronic transfer” generally refers to a transaction in which funds or cryptocurrency are moved from an account (or wallet) of one electronic transfer service provider to another. The term electronic transfer is intended to encompass wire transfers, ACH transfers, P2P transfers, and cryptocurrency transfers.

As used herein, a “sender” or “payor” generally refers to the person associated with an account from which the funds or assets specified by an electronic transfer are to be transferred or debited. Generally, the sender is the party of an electronic transfer that initiates the electronic transfer or on behalf of whom the electronic transfer is initiated.

As used herein, a “recipient” or “payee” generally refers to the person associated with an account to which the funds or assets specified by an electronic transfer are to be transferred or credited.

As used herein, a “shared secret” generally refers to a piece of data, known and previously agreed by the parties (i.e., a sender or payor and a recipient or payee) of an electronic transfer to be used to verify transaction details associated with the electronic transfer. It is generally preferable for the shared secret to be associated with a prior oral or written communication exchanged between the parties. Non-limiting examples of a shared secret may include an invoice number, a personal identification number (PIN), a passphrase, a real estate title number, a phone number, a purchase order (PO) number, and a passcode. For example, the sender may be performing the electronic transfer (e.g., a wire transfer, an ACH transfer, a P2P transfer, or a cryptocurrency transfer) to the remit payment to the recipient for a particular invoice issued by the recipient. In this example, the sender and recipient may agree in advance that an electronic transfer made after issuance of a given invoice will be verified by both parties using the invoice number of the given invoice as the shared secret.

As used herein a “blockchain smart contract” or simply a “smart contract” generally refers to code written into a blockchain that executes the terms of an agreement or contract from outside the chain. Smart contracts are programmed to automatically execute when certain conditions are met, and can be used for a variety of purposes, including, but not limited to, buying, selling, or transferring cryptocurrency. A smart contract may automate actions that would otherwise be completed by the parties to the agreement or the contract, thereby removing the need for the parties to trust each other and reducing or eliminating the need for third-party intermediaries.

The terms “module,” “component,” “system,” and the like as used herein are intended to refer to a computer-related entity, either a software-executing general purpose processor, hardware, firmware, or a combination thereof. For example, a module or a component may be, but is not limited to being, a process running on a compute resource, an executable, a thread of execution, a program, and/or a computer.

### Example Operational Environment for Pre-Transaction Verification of Wire Transfers

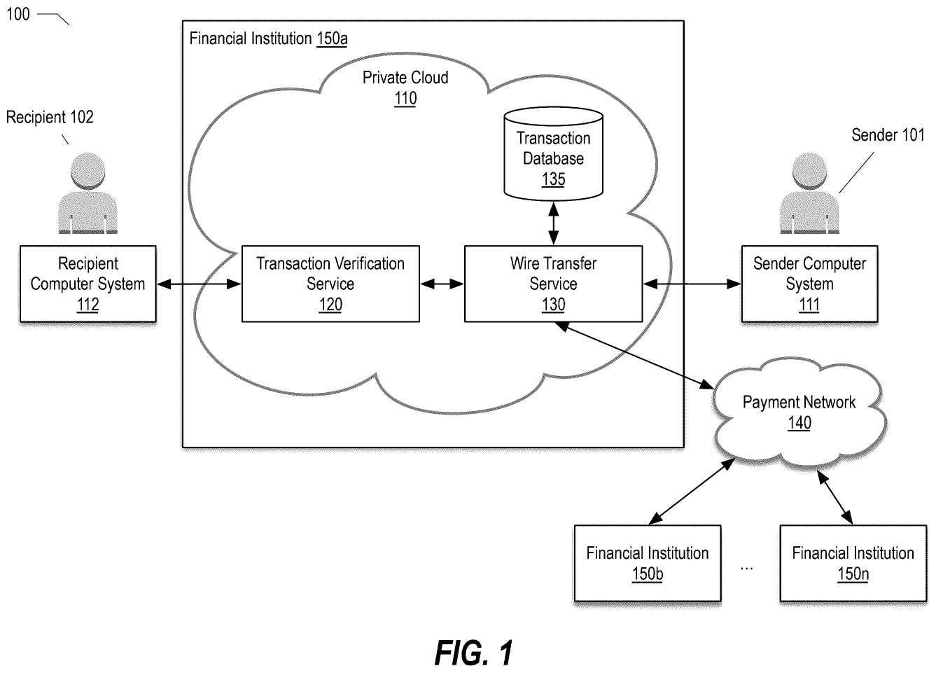

FIG. 1 is a high-level block diagram illustrating a transaction verification service implemented within a financial institution private cloud in accordance with an embodiment of the present disclosure. In the context of the present example, a private cloud 110 of a first financial institution (financial institution 150a) is shown including a wire transfer service 130, a transaction database 135, and a transaction verification service 120. The private cloud 110 may represent cloud infrastructure (e.g., in the form of a datacenter, a virtual private cloud within a public cloud, or the like) that is provisioned for exclusive use by the financial institution 150a. The private cloud 110 may be owned, managed, and operated by the financial institution 150a, a third party, or some combination of them, and may exist on or off premises.

In one embodiment, the wire transfer service 130 represents a microservice that causes wire transfers to be performed to move money electronically from an account of a sender (e.g., sender 101) maintained by the first financial institution 150a to an account of a recipient (e.g., recipient 102) maintained by a second financial institution (e.g., one of financial institutions 150b-n). The transaction database 135 may store, among other things, transaction details and associated reference identifiers (IDs) associated with in-process, pending, or completed wire transfers.

Financial institutions make use of a payment system or network (e.g., payment network 140) to perform wire transfers. Non-limiting examples of the payment network 140 include the Fedwire Funds Service, the National Settlement Service, and the SWIFT system. As the interactions with the payment network 140 are generally well-known and embodiments herein focus on verification and authentication processing performed by the transaction verification service 120 (e.g., before permitting a wire transfer to be requested via the payment network 140), the inner workings and other details associated with the payment network 140 will not be discussed further herein. Suffice it to say the payment network 140 acts as a carrier of messages containing payment instructions to transfer funds electronically between accounts of member banks.

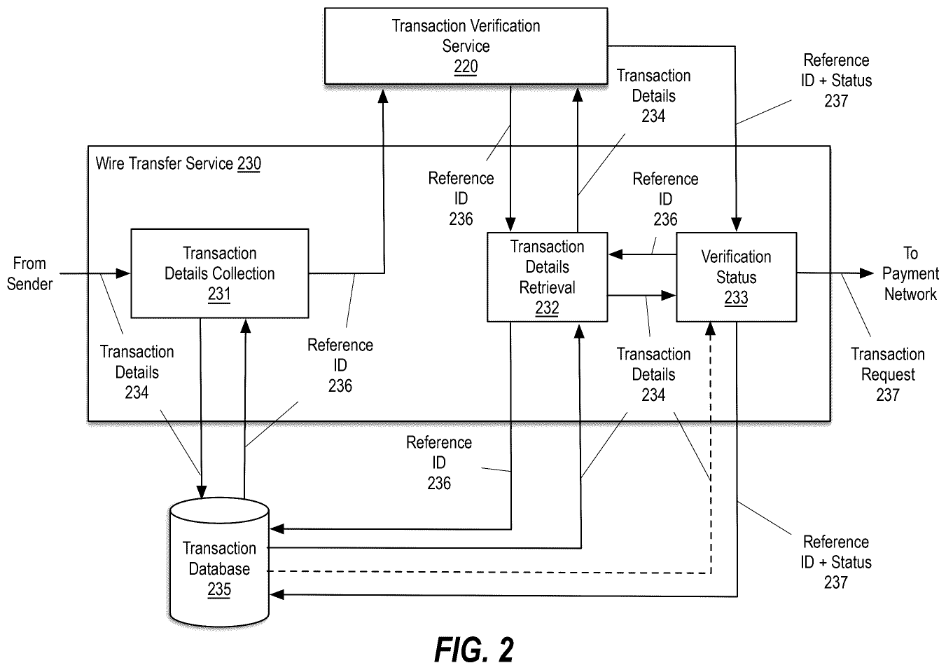

The wire transfer service 130 may be utilized directly or indirectly by the sender to electronically transfer funds from their account held by the financial institution 150a to an account of the recipient held at a second financial institution (e.g., one of financial institutions 150b-n). For example, the sender may initiate a wire transfer in person at a branch of the financial institution 150a with the assistance of a representative (e.g., a bank teller, a banker, a loan processor, an investment banker, or the like) of the financial institution 150a in which the representative inputs the transaction details on behalf of the sender into the financial institution's system (e.g., teller platform software, a core banking system, or the like). Alternatively or additionally, the sender may have the ability to request a wire transfer via a financial application (e.g., a mobile application, a web-based application, or a desktop application) provided by the financial institution 150a to its customers. A non-limiting example of the wire transfer service 130 is described further below with reference to FIG. 2.

In the context of the present example, the wire transfer service 130 is assumed to be accessible by sender 101 through the use of a financial application (not shown) installed on, running within a web browser (not shown) of, or otherwise in communication with a sender computer system 111 (e.g., a smartphone, a laptop computer, a tablet computer, a desktop computer, etc.).

As noted above, although the payment network 140 through which wire transfers are performed are generally considered to be secure, fraud and/or mistake may result in loss by the sender of the funds associated with a wire transfer given the very limited ability to reverse or cancel wire transfers. According to various embodiments described herein, the transaction verification service 120 (e.g., a separate microservice deployed within the private cloud 110) may be invoked by the wire transfer service 130 to request performance of pre-transaction verification of transaction details associated with a given wire transfer and authentication of the recipient by the transaction verification service 120 before initiating the given wire transfer via the payment network 140. Advantageously, use of the transaction verification service 120 may prevent loss by the sender of the funds associated with a wire transfer by identifying potential mistakes in the transaction details and/or by identifying potential fraud. The transaction verification service 120 may be offered by the financial institution 150a as an additional (paid or free) service to provide its customers with peace of mind that the funds associated with a given wire transfer are of the proper amount, will be delivered to the correct account, and the account is owned or managed by an authenticated individual. In one embodiment, the transaction verification service 120 represents functionality implemented by a third-party and which may expose one or more third-party APIs (e.g., REST APIs) for use by the wire transfer service 130. Alternatively, the transaction verification service 120 may represent functionality implemented by information technology (IT) professionals associated with the financial institution 150a.

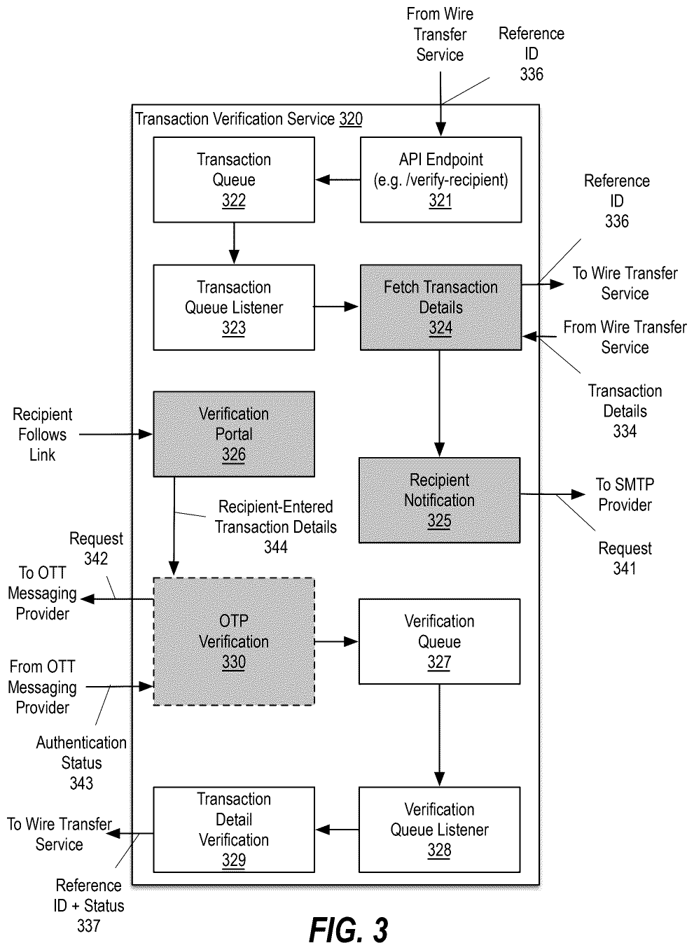

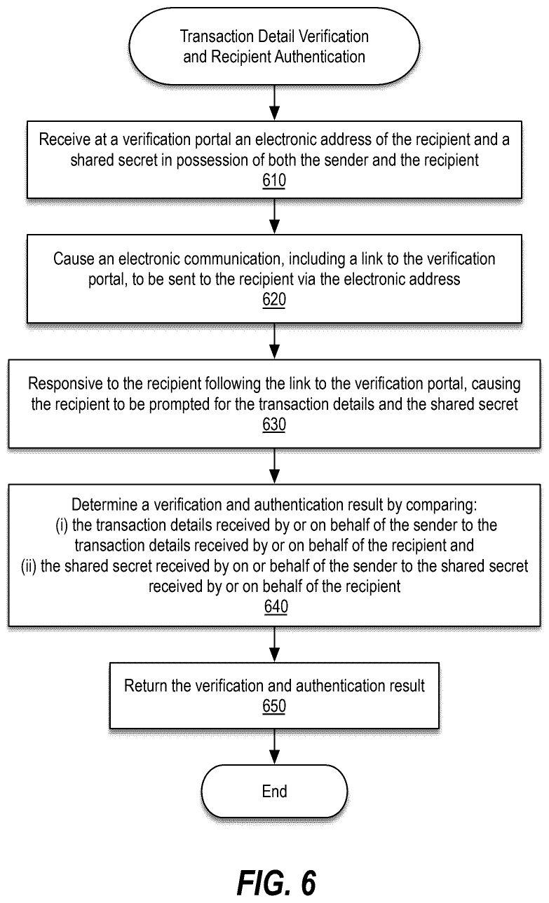

As described further below with reference to FIGS. 3 and 6, the transaction verification service 120 may be responsible for one or both of verifying the transaction details (e.g., the name of the recipient, contact details for the recipient, an amount of funds to be transferred from the account of the sender to the account of the recipient, a financial institution ID of the financial institution at which the recipient's account is maintained, an account number of the recipient's account, and a shared secret in possession of both of the sender and the recipient) associated with the wire transfer and authenticating the recipient.

### Example Wire Transfer Service

FIG. 2 is a block diagram illustrating an example of a wire transfer service 230 in accordance with an embodiment of the present disclosure. Wire transfer service 230 represents a non-limiting example of wire transfer service 130 of FIG. 1. In the context of the present example, wire transfer service 230 is shown including a transaction details collection component 231, a transaction details retrieval component 232, and a verification status component 233.

The transaction details collection component 231 may represent a module or API endpoint (e.g., a REST API method) through which sender-provided transaction details (e.g., transaction details 234) relating to an electronic transfer (in this case, a wire transfer) input by or on behalf of the sender (e.g., sender 101) may be received by the wire transfer service 230. After receiving the transaction details 234, the transaction details collection component 231 may further be responsible for persisting the transaction details 234 to a transaction database 235 (which may be analogous to transaction database 135), receiving a reference identifier (ID) 236 from the transaction database 235 that corresponds to the persisted transaction details 234 (and the wire transfer at issue), and requesting a transaction verification service 220 (which may be analogous to transaction verification service 120) to perform pre-transaction verification and authentication to enhance the security of the wire transfer. Depending on the particular implementation, the reference ID may be the bank transfer reference number (or transaction ID) created for the in-process wire transfer or may be a separate ID associated with the in-process wire transfer.

The transaction details retrieval component 232 may represent a module or API endpoint (e.g., a REST API method) exposed for use by the transaction verification service 220 to retrieve transaction details 234 for a given reference ID 236. Based on the given reference ID 236, the corresponding transaction details 234 may be retrieved from the transaction database 235 on behalf of the transaction verification service 220 and returned to the transaction verification service 220. In this manner, the information security principle of least privilege (e.g., restricting access of computing processes to only those resources absolutely required to perform legitimate functions) is enforced. For example, to the extent the transaction verification service 220 represents functionality implemented by a third-party, security and integrity of the transaction database 235 is maintained by limiting access to the transaction verification service 220 to only transaction details 234 corresponding to a reference ID 236 of a wire transfer for which the wire transfer service 230 has expressly requested pre-transaction verification and authorization to be performed by the transaction verification service 220.

The verification status component 233 may represent a module or API endpoint (e.g., a REST API method) exposed for use by the transaction verification service 220 to communicate the result of the pre-transaction verification and authentication performed by the transaction verification service 220. In the context of the present example, the transaction verification service 220 provides a reference ID and status 237 to the verification status component 233 to indicate either an affirmative verification and authentication result for a given reference ID or a negative verification and authentication result for the given reference ID. The verification status component 233 may be responsible for updating the status of the electronic fund transfer (initially marked as pending or in-process, for example) to “verified,” “verified and authenticated,” or the like. As described further below, an affirmative verification and authentication result emitted by the transaction verification service 220 may be used to confirm to the wire transfer service 230 that the sender-provided transaction details match those confirmed by the recipient (e.g., recipient 102), for example, via interactions with the recipient through a recipient computer system 112 (e.g., a smartphone, a laptop computer, a tablet computer, a desktop computer, etc.) and that the recipient has also been authenticated by one or more of various means. In contrast, a negative verification and authentication result may be used by the transaction verification service 220 to inform the wire transfer service 230 that the sender-provided transaction details do not match those confirmed by the recipient (e.g., recipient 102) or that the recipient could not be authenticated by one or more of various means. If and only if an affirmative verification and authentication result is received from the transaction verification service 220, the verification status component 233 may further be responsible for causing the wire transfer corresponding to the reference ID to be performed by the payment network (e.g., payment network 140), for example, by sending a transaction request 237 that includes an appropriate subset of the transaction details 234. For example, the verification status component 233 may make use of the transaction details retrieval component 232 to retrieve the transaction details 234 corresponding to the reference ID 236 from the transaction database 235. Alternatively, the verification status component 233 may directly query the transaction database 235 for the transaction details 234 corresponding to the reference ID 236.

While in the context of the present example, it is assumed the transaction database 235 assigns a reference ID to each individual electronic fund transfer, in other examples the transaction information collection module 231 or some other component of the wire transfer service 230 may assign the reference IDs.

While in the context of the present example, it is assumed the verification status component 233 causes a given wire transfer to be initiated via the payment network after receiving an affirmative verification and authentication result from the transaction verification service 220, in other examples, another component of the wire transfer service 230 may perform this function.

### Example Transaction Verification Service

FIG. 3 is a block diagram illustrating an example of a transaction verification service 320 in accordance with an embodiment of the present disclosure. Transaction verification service 320 represents a non-limiting example of transaction verification service 120 of FIG. 1. The transaction verification service 320 may be responsible for one or both of verifying transaction details associated with a given electronic transfer (in this case, a wire transfer) and authenticating the recipient (e.g., recipient 102) of the wire transfer. The transaction details may include the name of the recipient, contact details for the recipient, an amount of funds to be transferred from the account of the sender (e.g., sender 101) to the account of the recipient, a financial institution ID of the financial institution (e.g., one of financial institutions 150b-n) at which the recipient's account is maintained, an account number of the recipient's account, and a shared secret in possession of both of the sender and the recipient.

In the context of the present example, transaction verification service 320 is shown including an API endpoint 321, a transaction queue 322, a transaction queue listener 323, a fetch transaction details module 324, a recipient notification module 325, a verification portal 326, an optional one-time password (OTP) verification module 330, a verification queue 327, a verification queue listener 328, and a transaction detail verification module 329.

The API endpoint 321 (e.g., a REST API method, such as/verify-recipient) represents an API method exposed for use by the wire transfer service (e.g., wire transfer service 130 or 230), for example, as shown in FIG. 2, a transaction details collection component (e.g., transaction details collection component 231) may invoke the API method with a reference ID 336 (which may be analogous to reference ID 236) associated with the wire transaction at issue to request the performance of pre-transaction verification and authentication by the transaction verification service 320.

The transaction queue 322 may represent an advanced messaging queue (e.g., a RabbitMQ message broker) logically interposed between a producer (e.g., API endpoint 321) and a consumer (e.g., the transaction queue listener 323) that provides temporary storage for reference IDs queued by the API endpoint 321.

The transaction queue listener 323 is responsible for reading and processing the messages (e.g., the reference IDs 336) queued on the transaction queue 322 by the API endpoint 321 as requests are received from the wire transfer service. According to one embodiment, the transaction queue listener 323 launches a new task (represented by the gray components, including the fetch transaction details module 324, the receipt notification module 325, the verification portal 326, and the optional OTP verification module 330).

The fetch transaction details module 324 is responsible for interacting with the wire transfer service to obtain transaction details 334 for a given reference ID supplied by the transaction queue listener 323. For example, the fetch transaction details module 324 may call an API method (e.g., the transaction details retrieval component 232) exposed by the wire transfer service with the given reference ID and the API method returns the transaction details 334 (e.g., the name of the recipient, contact details for the recipient, an amount of funds to be transferred from the account of the sender to the account of the recipient, a financial institution ID of the financial institution at which the recipient's account is maintained, an account number of the recipient's account, and a shared secret in possession of both of the sender and the recipient). After receipt of the transaction details 334 from the wire transfer service, the fetch transaction details module 324 may provide all or some subset of the transaction details 33 to the receipt notification module 325. For example, the fetch transaction details module 324 may call the recipient notification module 325 with a parameter representing all or some subset of the transaction details 334 or may store all or some subset of the transaction details 334 in a memory accessible to the recipient notification module 325.

The recipient notification module 325 is responsible for causing a notification regarding the in-process wire transfer at issue to be electronically communicated to the recipient. The recipient notification module 325 may make use of an electronic address (e.g., a mobile telephone number or an email address) of the recipient that is included as part of the sender-provided transaction details 334 to cause an electronic communication (e.g., an email or a text message) to be delivered to the recipient. In one embodiment, the recipient may be authenticated by causing a Simple Mail Transfer Protocol (SMTP) provider (e.g., SendGrid or the like) to send an email message to the recipient, which they can access via a recipient computer system (e.g., recipient computer system 112, such as a smartphone, a laptop computer, a tablet computer, a desktop computer, etc.). The electronic communication may inform the recipient of the in-process wire transfer and may include a link (which may also be referred to herein as a verification link) to the verification portal 326. By virtue of the recipient following the link or otherwise navigating to the verification portal 326 based on the link, the email address of the recipient has been authenticated.

In order to verify both the sender and the recipient agree on all or some subset of the transaction details, for example, one or more of the name of the recipient, contact details for the recipient, an amount of funds to be transferred from the account of the sender to the account of the recipient, a financial institution ID of the financial institution at which the recipient's account is maintained, an account number of the recipient's account, and a shared secret in possession of both of the sender and the recipient, the verification portal 326 may be responsible for collecting the transaction details from the recipient (referred to as the recipient-entered transaction details 344). The verification portal 326 may also be responsible for invoking the optional OTP verification module 330 or queueing the recipient-entered transaction details 334 on the verification queue 327. Depending on the particular implementation the verification portal 326 may represent a web page, for example, that presents one or more online forms to the recipient, prompting the recipient for all or a subset of the transaction details that are to be matched/verified as well as the shared secret.

The OTP verification module 330, if employed, may be responsible for causing an OTP to be to be electronically communicated to the recipient by sending a request 342 to an external service provider (e.g., an over-the-top (OTT) messaging provider). The OTP verification module 330 may make use of an electronic address (e.g., a mobile telephone number or an email address) of the recipient that is included as part of the recipient-provided transaction details 344 or the sender-provided transaction details 334 to cause an electronic communication (e.g., an email or a text message) to be delivered to the recipient. In one embodiment, the recipient may be authenticated by causing an OTT messaging provider (e.g., Twilio or the like) to send a text message containing an OTP to the recipient, which they can access via a recipient computer system (e.g., recipient computer system 112, such as a smartphone, a laptop computer, a tablet computer, a desktop computer, etc.). The OTP verification module 330 may also be responsible for receiving an authentication status 343 from the OTT messaging provider (or from the verification portal 326, depending on the particular implementation) indicating whether the recipient correctly confirmed the OTP. In the context of the present example, after receipt of an affirmative authentication status 343, the OTP verification module 330 may queue the recipient-entered transaction details 344 on the verification queue 327.

The verification queue 327 may represent an advanced messaging queue (e.g., a RabbitMQ message broker) logically interposed between a producer (e.g., the OTP verification module 330) and a consumer (e.g., the verification queue listener 328) that provides temporary storage for the recipient-entered transaction details 344.

The verification queue listener 328 is responsible for reading and processing the messages (e.g., the recipient-entered transaction details 344) queued on the transaction queue 322 by the optional OTP verification module 330 or the verification portal 326 as they are available. According to one embodiment, the verification queue listener 327 may make use of the transaction detail verification module 329 to compare and verify the sender-entered transaction details 334 against the recipient-entered transaction details 344.

The transaction detail verification module 329 may be responsible for comparing, on a field-by-field basis, the sender-entered transaction details 334 against the recipient-entered transaction details 344 and returning a reference ID and status 337 to the wire transfer service. For example, the transaction detail verification module 329 may determine a verification and authentication result by comparing (i) the transaction details received by or on behalf of the sender to the transaction details received from the recipient and (ii) the shared secret received by or on behalf of the sender to the shared secret received from the recipient. If all of the recipient-entered transaction details 344 match corresponding fields of the sender-entered transaction details 334, then the reference ID of the in-process wire transaction at issue will be returned to the wire transfer service along with a status representing an affirmative verification and authentication result; otherwise, the reference ID of the in-process wire transaction at issue will be returned to the wire transfer service along with a status representing a negative verification and authentication result. In one embodiment, the verification link may have a predetermined or configurable period of validity. For example, the verification link may only be valid for a number of hours (e.g., 1-6 hours). In such a case, if the recipient does not visit the verification portal within the prescribed time limit, a negative verification and authentication result is returned to the wire transfer service.

In one embodiment, the wire transfer service initiates the wire transfer with the payment network (e.g., payment network 140) if and only if the transaction details input by or on behalf of the sender are confirmed by the transaction verification service 320 to match those entered by or on behalf of the recipient, including a shared secret agreed to be used to secure the wire transfer.

As noted above, as an additional precaution, the recipient may also be prompted by the verification portal 326 or the OTT messaging provider to confirm an OTP sent to the mobile phone of the recipient via the OTT messaging provider to confirm the wire transfer is going to the right person. When OTP verification is performed, an affirmative verification and authentication result indicates the recipient correctly confirmed the OTP and the recipient-entered transaction details 344 match the sender-entered transaction details 334. If the recipient fails to correctly confirm the OTP or any fields of the recipient-entered transaction details 344 fail to match corresponding fields of the sender-entered transaction details 334, then a negative verification and authentication result will be returned to the wire transfer service and the in-process wire transfer will not be initiated via the payment network.

### Example Screen Shots

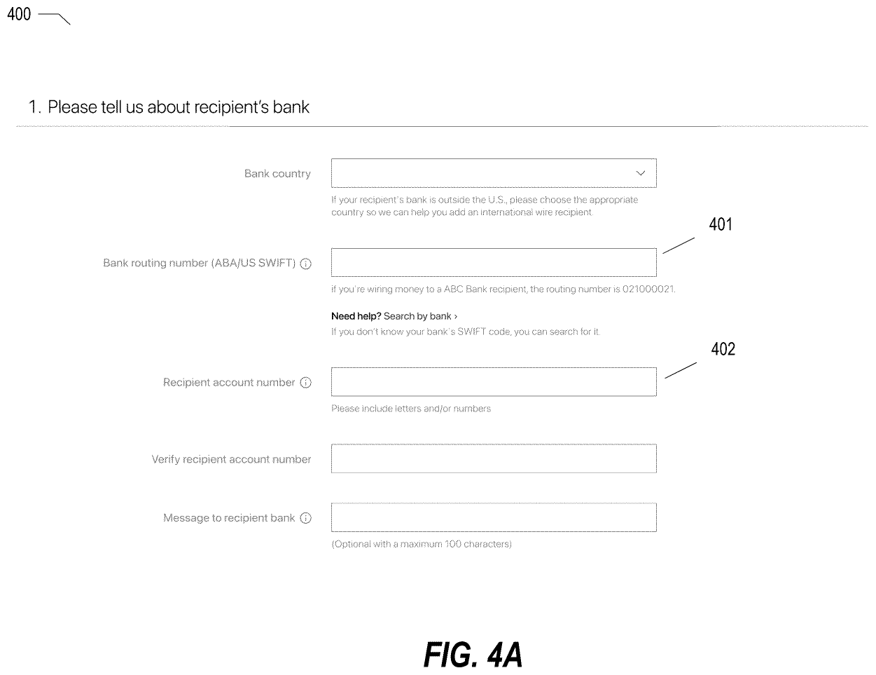

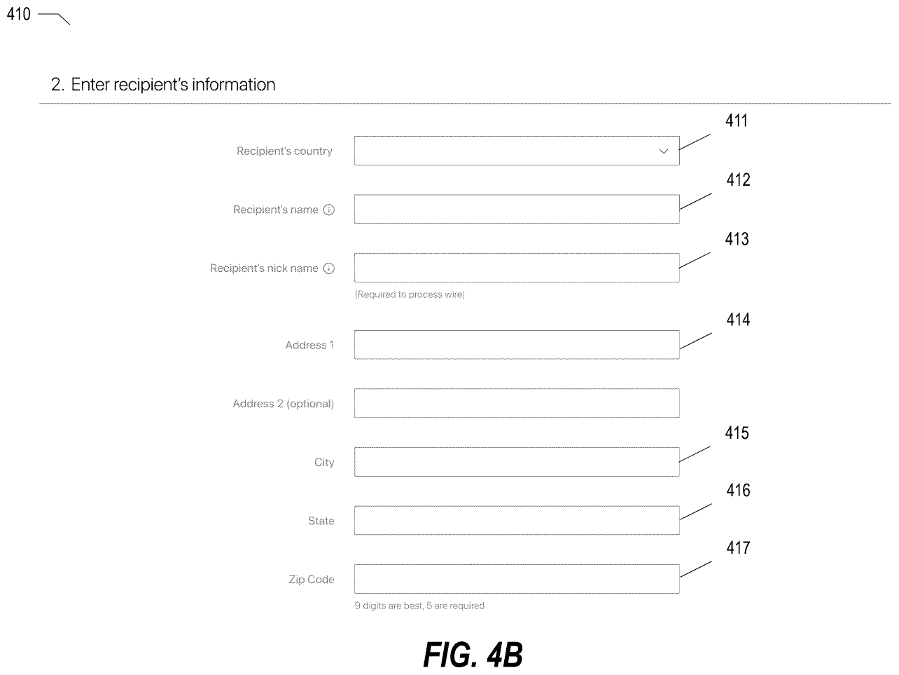

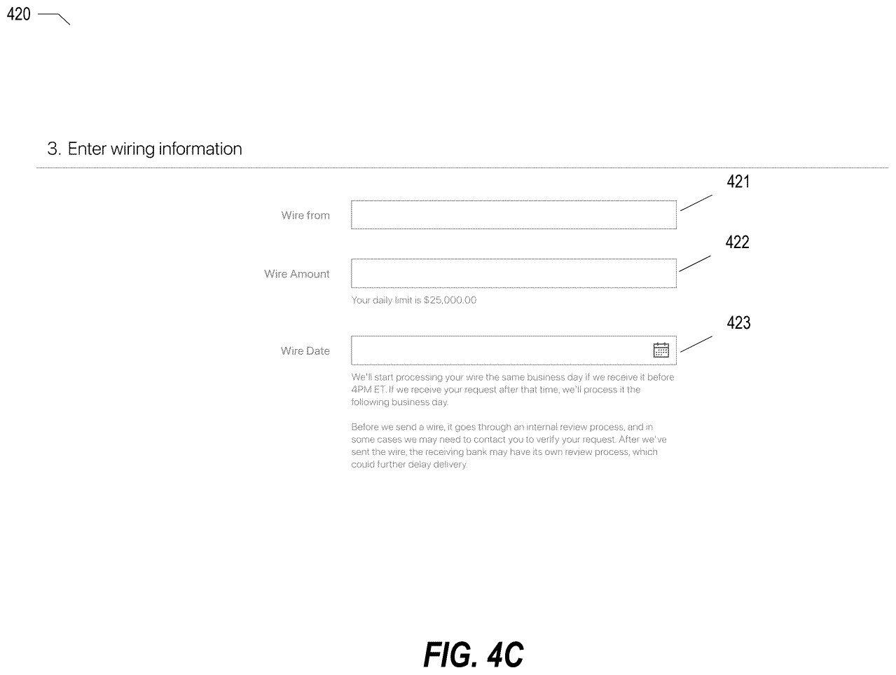

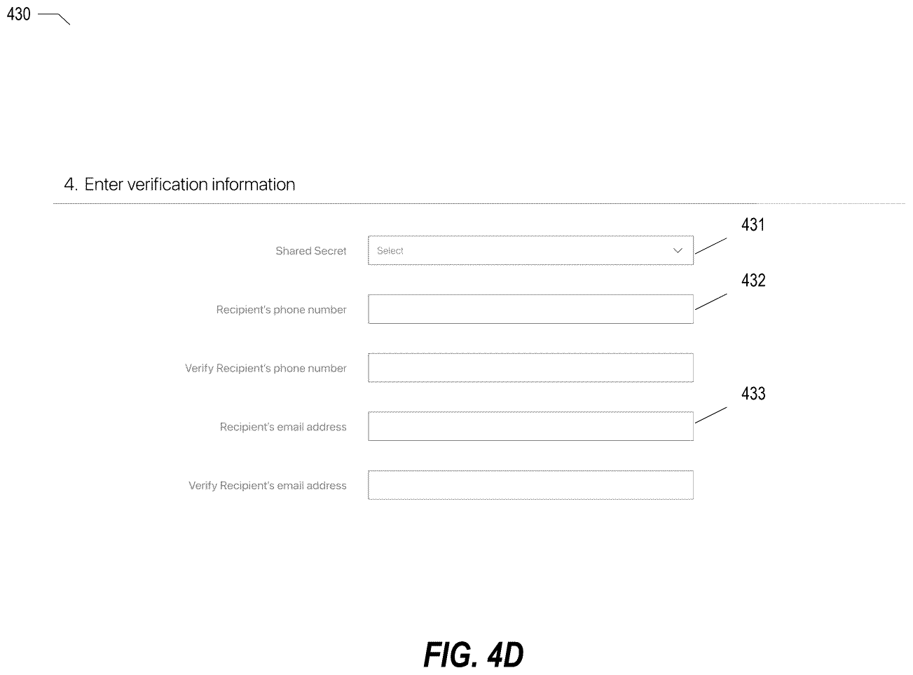

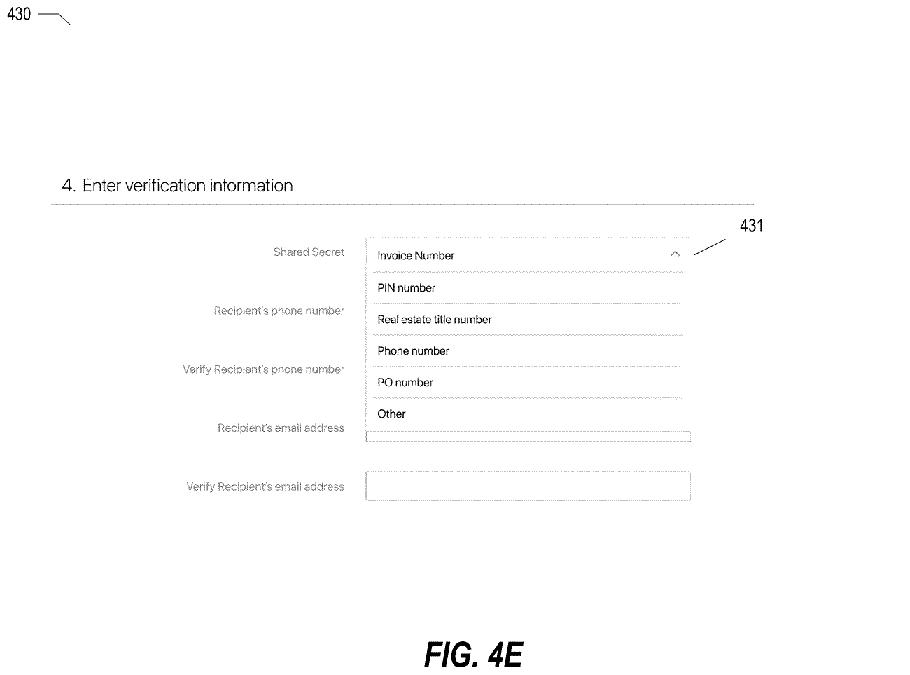

FIGS. 4A-E are example screen shots (400, 410, 420, and 430) of a mobile or desktop financial application for collecting transaction details relating to a wire transfer in accordance with an embodiment of the present disclosure. In the context of FIG. 4A, information may be entered by or on behalf of the sender (e.g., sender 101) relating to the financial institution (e.g., bank) of the recipient (e.g., recipient 102). For example, fields (e.g., 401 and 402, etc.) may be presented via a user interface of a financial application (or teller platform software, a core banking system or the like) into which information regarding the country in which the recipient's bank is located, the bank routing number, the recipient's account number, and the like may be entered.

As shown in FIG. 4B, information may further be entered by or on behalf of the sender relating to the recipient. For example, fields (e.g., 411-417, etc.) may be presented via a user interface of a financial application (or teller platform software, a core banking system or the like) into which information regarding the recipient's country, the recipient's name (e.g., full legal name, one or more of a first name, middle name, middle initial, and last name, or the name as it appears on their bank account), the recipient's nickname, the recipient's address (e.g., residence or business address), including a street address, a city, a state, and Zip Code.

As shown in FIG. 4C, wiring information may further be entered by or on behalf of the sender, for example, including an account from which the funds associated with the wire transfer are to be sent or debited (e.g., field 421), the amount of funds (e.g., filed 422) to be transferred to the recipient, and a date (e.g., filed 423) on which the wire transfer is to be performed.

As shown in FIGS. 4D-E, verification information may further be entered by or on behalf of the sender that is to be verified or used to authenticate the recipient in addition to verification of one or more of, potentially among other information, the recipient's account number, the financial institution ID (e.g., the ABA routing number or SWIFT code) of the financial institution associated with the recipient's account. In FIGS. 4D-E, the verification information includes a shared secret, representing a piece of data or information that was previously agreed by the parties of the wire transfer to be used to verify transaction details associated with the wire transfer. For example, by convention, the parties may agree during a prior oral or written communication exchanged between the parties that a wire transfer made after issuance of a given invoice by the recipient to the sender will be verified by both parties using the invoice number of the given invoice as the shared secret. Other non-limiting examples of a shared secret include a PIN, a real estate title number, a phone number, a PO number, and the like. As depicted in FIG. 4E, the type of shared secret may be selected from a predetermined or configurable list from a drop down list 431.

### Example Wire Transaction Pre-Processing

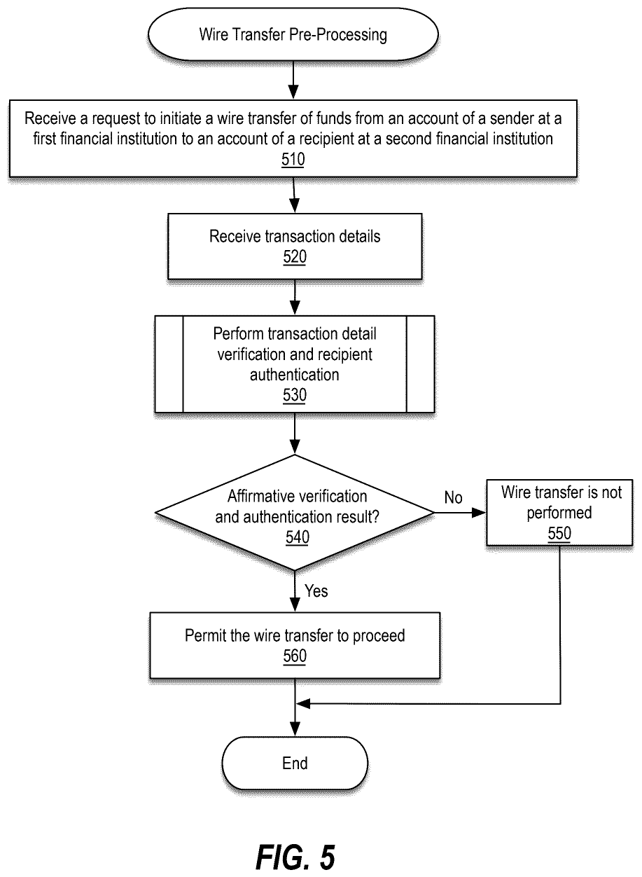

FIG. 5 is a flow diagram illustrating operations for performing wire transaction pre-processing in accordance with an embodiment of the present disclosure. The processing described with reference to FIG. 5 may be performed by a wire transfer service (e.g., wire transfer service 130), a transaction verification service (e.g., transaction verification service 120), or by a combination thereof.

At block 510, a request is received to initiate a wire transfer of funds from an account of a sender (e.g., sender 101) at a first financial institution (e.g., financial institution 150a) to an account of a recipient (e.g., recipient 102) at a second financial institution (e.g., one of financial institutions 150b-n). For example, the request may be generated by a financial application (e.g., a mobile application, a web-based application, or a desktop application) based on input provided by the sender. Alternatively, the request may be generated on behalf of the sender by personnel associated with a branch of the financial institution, for example, a bank teller, a banker, a load processor, or an investment banker, interacting with an internal system (e.g., teller platform software, a core banking system, or the like) utilized by the financial institution.

At block 520, the transaction details associated with the wire transfer are received. The transaction details may include, among others, one or more of the name of the recipient, contact details for the recipient, an amount of funds to be transferred from the account of the sender to the account of the recipient, a financial institution ID of the financial institution at which the recipient's account is maintained, an account number of the recipient's account, and a shared secret in possession of both of the sender and the recipient) associated with the wire transfer and authenticating the recipient.

At block 530, pre-verification processing, including, for example, transaction detail verification and recipient authentication are performed. For example, in an effort to avoid wire transfer fraud and/or a mistaken fund transfer to an incorrect account, all or some subset of the transaction details of the wire transfer may be verified. Additionally, the recipient of the wire transfer may be authenticated. A non-limiting example of transaction detail verification and recipient authentication is described further below with reference to FIG. 6.

At decision block 540, it is determined whether the transaction detail verification and recipient authentication performed at block 530 returned an affirmative verification and authentication result. If so, processing continues with block 560; otherwise, processing branches to block 550.

At block 560, the wire transfer is permitted to proceed. For example, an affirmative verification and authentication result may be emitted by the transaction verification service to the wire transfer service to confirm to the wire transfer service that the sender-provided transaction details match those confirmed by the recipient, for example, as entered by the recipient via a verification portal (e.g., verification portal 326) and that the recipient has also been authenticated by one or more of various means (e.g., by email and/or text message). At this point, wire transfer pre-processing is complete.

At block 550, wire transfer processing is not performed and the wire transfer pre-processing is complete. For example, a negative verification and authentication result may be emitted by the transaction verification service to inform the wire transfer service that the sender-provided transaction details do not match those input by the recipient or that the recipient could not be authenticated by one or more of various means. At this point, if the sender is confident no fraud is involved, the sender may contact the recipient to determine what information is in error and potentially re-try the wire transaction; otherwise, the sender may have been protected from a potentially fraudulent scheme.

### Example Wire Transaction Detail Verification and Recipient Authentication

FIG. 6 is a flow diagram illustrating operations for performing transaction detail verification and recipient authentication in accordance with an embodiment of the present disclosure. The processing described with reference to FIG. 6 represent a non-limiting example of operations that may be performed as part of block 530 of FIG. 5 and may be performed by a wire transfer service (e.g., wire transfer service 130), a transaction verification service (e.g., transaction verification service 120), or by a combination thereof.

At block 610, a verification portal may receive an electronic address (e.g., a mobile phone number and/or an electronic mail (email) address) of the recipient and the shared secret. To the extent earlier provided as part of the gathering of wire transaction details, this information may be provided to the verification portal by the wire transfer service or by the transaction verification service. To the extent not provided earlier, the verification portal may collect this information from the sender or his/her designee.

At block 620, an electronic communication (e.g., an email directed to the email address of the recipient or an SMS message directed to the mobile phone number of the recipient), including a link (e.g., a uniform resource locator (URL)) to a verification portal (e.g., verification portal 326) is caused to be sent to the recipient. For example, the recipient may be informed of the in-process wire transfer and authenticated by the transaction verification service by causing an SMTP provider (e.g., SendGrid or the like) to send an email message to the recipient. In addition to providing the link to the verification portal, the electronic communication may inform the recipient of the in-process wire transfer. By virtue of the recipient following the link or otherwise navigating to the verification portal based on the link, the email address of the recipient may be considered to have been authenticated.

At block 630, responsive to the recipient following the link to the verification portal (or otherwise directing a web browser to the verification portal, for example, by cutting and pasting the link into the address bar of the web browser), the recipient may be prompted to enter the transaction details associated with the wire transfer, including the shared secret.

At block 640, a verification and authentication result is determined by comparing (i) the transaction details received by or on behalf of the sender to the transaction details received by or no behalf of the recipient and (ii) the shared secret received by or on behalf of the sender to the shared secret received by or on behalf of the recipient. Based on a determination that the sender-provided and recipient-provided transaction details match and the shared secret provided by both parties match a flag, Boolean value, or enumerated value, representing the verification and authentication result may set to 1, true, success or the like. Based on a determination that the sender-provided and recipient-provided transaction details do not match (e.g., a routing number mismatch, an account number mismatch, an amount mismatch, etc.) and/or that the shared secrets input by the respective parties do not match, the flag, Boolean value, or enumerated value, representing the verification and authentication result may set to 0, false, failed, or the like. In one embodiment, in addition to having received the link to the verification portal, authentication of the recipient may also include confirming by an OTP verification module (e.g., OTP verification module 330) or via the verification portal that the recipient has correctly confirmed an OTP, for example, sent to the recipient via an SMS message directed to a mobile phone number of the recipient.

At block 650, the verification and authentication result is returned, for example, from the transaction verification service to the wire transfer service.

While in the context of the flow diagrams of FIGS. 5 and 6, a number of enumerated blocks are included, it is to be understood that other examples may include additional blocks before, after, and/or in between the enumerated blocks. Similarly, in some examples, one or more of the enumerated blocks may be omitted and/or performed in a different order.

### Example Operational Environment for Pre-Transaction Verification of ACH Transfers

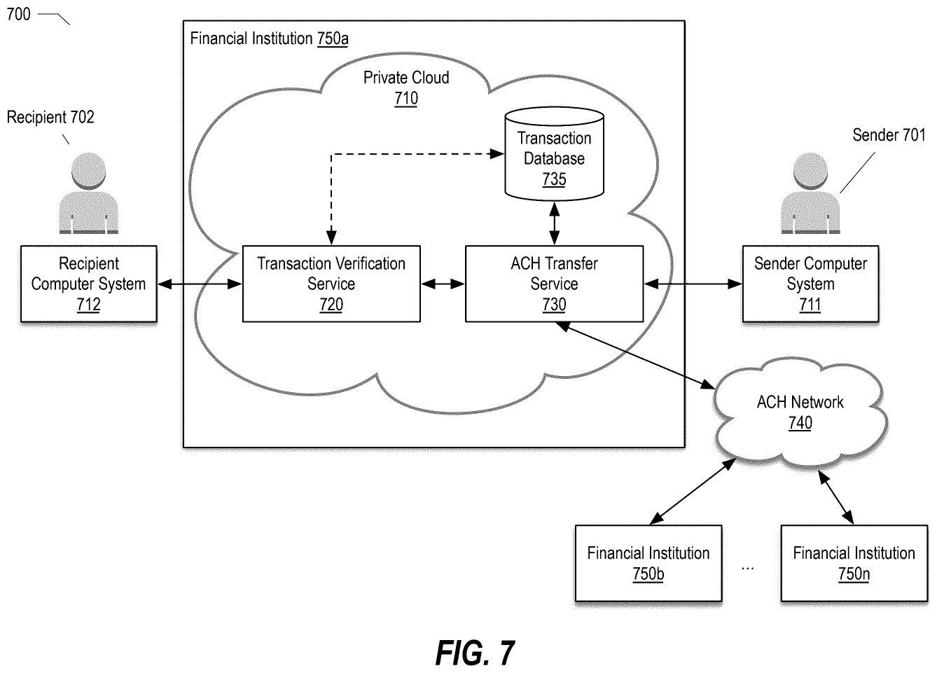

FIG. 7 is a high-level block diagram illustrating a transaction verification service implemented within a financial institution private cloud in accordance with an embodiment of the present disclosure. In the context of the present example, a private cloud 710 of a first financial institution (financial institution 750a) is shown including an ACH transfer service 730, a transaction database 735, and a transaction verification service 720. The private cloud 710 may represent cloud infrastructure (e.g., in the form of a datacenter, a virtual private cloud within a public cloud, or the like) that is provisioned for exclusive use by the financial institution 750a. The private cloud 710 may be owned, managed, and operated by the financial institution 750a, a third party, or some combination of them, and may exist on or off premises.

In one embodiment, the ACH transfer service 730 represents a microservice that causes ACH transfers to be performed to move money electronically from an account of a sender (e.g., sender 701) maintained by the first financial institution 750a to an account of a recipient (e.g., recipient 702) maintained by the same or a different financial institution (e.g., one of financial institutions 750b-n). The transaction database 735 may store, among other things, transaction details and associated reference identifiers (IDs) associated with in-process, pending, or completed ACH transfers.

Financial institutions make use of a payment system or network (e.g., ACH network 740) to perform ACH transfers. As the interactions with the ACH network 740 are generally well-known and embodiments herein focus on verification and authentication processing performed by the transaction verification service 720 (e.g., before permitting an ACH transfer to be requested via the ACH network 740), the inner workings and other details associated with the ACH network 740 will not be discussed further herein. Suffice it to say the ACH network 740 acts as a carrier of messages containing payment instructions to transfer funds electronically between accounts of member banks.

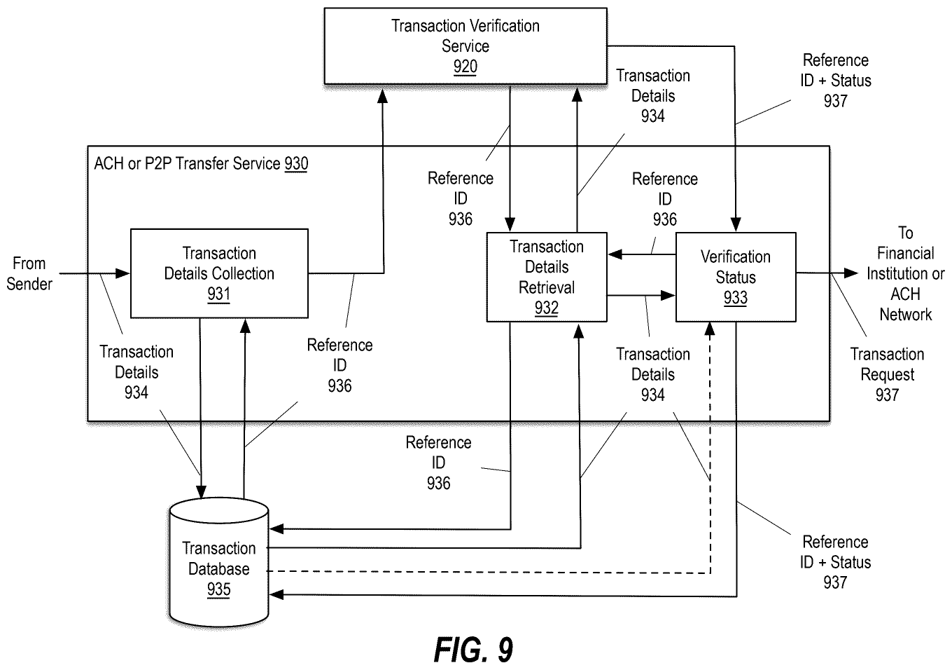

The ACH transfer service 730 may be utilized directly or indirectly by the sender to electronically transfer funds from their account held by the financial institution 750a to an account of the recipient held at the same or a different financial institution (e.g., one of financial institutions 750b-n). For example, the sender may initiate an ACH transfer in person at a branch of the financial institution 750a with the assistance of a representative (e.g., a bank teller, a banker, a loan processor, an investment banker, or the like) of the financial institution 750a in which the representative inputs the transaction details on behalf of the sender into the financial institution's system (e.g., teller platform software, a core banking system, or the like). Alternatively or additionally, the sender may have the ability to request an ACH transfer via a financial application (e.g., a mobile application, a web-based application, or a desktop application) provided by the financial institution 750a to its customers. A non-limiting example of the ACH transfer service 730 is described further below with reference to FIG. 9.

In the context of the present example, the ACH transfer service 730 is assumed to be accessible by sender 701 through the use of a financial application (not shown) installed on, running within a web browser (not shown) of, or otherwise in communication with a sender computer system 711 (e.g., a smartphone, a laptop computer, a tablet computer, a desktop computer, etc.).

As noted above, although the ACH network 740 through which ACH transfers are performed are generally considered to be secure, fraud and/or mistake may result in loss by the sender of the funds associated with an ACH transfer. While the time frame of an ACH transfer, which may take multiple days to settle, provides more time to stop or reverse such a transaction, the rules for stopping or reversing ACH transfers can vary depending on the particular financial institution.

According to various embodiments described herein, the transaction verification service 720 (e.g., a separate microservice deployed within the private cloud 710) may be invoked by the ACH transfer service 730 to request performance of pre-transaction verification of transaction details associated with a given ACH transfer and authentication of the recipient by the transaction verification service 720 before initiating the given ACH transfer via the ACH network 740. Advantageously, use of the transaction verification service 720 may prevent loss by the sender of the funds associated with an ACH transfer by identifying potential mistakes in the transaction details and/or by identifying potential fraud. The transaction verification service 720 may be offered by the financial institution 750a as an additional (paid or free) service to provide its customers with peace of mind that the funds associated with a given ACH transfer are of the proper amount, will be delivered to the correct account, and the account is owned or managed by an authenticated individual. In one embodiment, the transaction verification service 720 represents functionality implemented by a third-party and which may expose one or more third-party APIs (e.g., REST APIs) for use by the ACH transfer service 730. Alternatively, the transaction verification service 720 may represent functionality implemented by information technology (IT) professionals associated with the financial institution 750a.

As described further below, similar to transaction verification service 120 and 220 of FIGS. 1 and 2, the transaction verification service 720 may be responsible for one or both of verifying the transaction details (e.g., the name of the recipient, contact details for the recipient, an amount of funds to be transferred from the account of the sender to the account of the recipient, a financial institution ID (in this case, an ACH routing number, to the extent different from the financial institution's ABA routing number) of the financial institution at which the recipient's account is maintained, an account number of the recipient's account, and a shared secret in possession of both of the sender and the recipient) associated with the ACH transfer and authenticating the recipient.

### Example Operational Environment for Pre-Transaction Verification of P2P Transfers

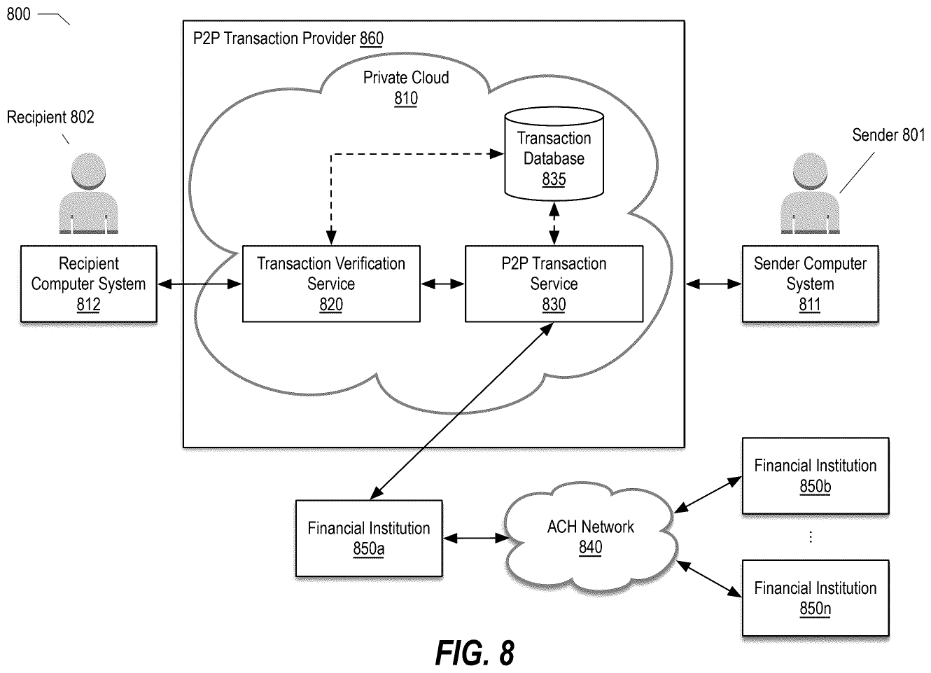

FIG. 8 is a high-level block diagram illustrating a transaction verification service implemented within a P2P payment system private cloud in accordance with an embodiment of the present disclosure. In the context of the present example, a private cloud 810 of an electronic transfer service provider (e.g., P2P transaction provider 860) is shown including a P2P transfer service 830, a transaction database 835, and a transaction verification service 820. The P2P transaction provider 860 may represent a financial services company or a P2P payment system (e.g., Zelle, Venmo, PayPal, Cash App, or the like). The private cloud 810 may represent cloud infrastructure (e.g., in the form of a datacenter, a virtual private cloud within a public cloud, or the like) that is provisioned for exclusive use by the P2P transaction provider 860. The private cloud 810 may be owned, managed, and operated by the P2P transaction provider 860, a third party, or some combination of them, and may exist on or off premises.

In one embodiment, the P2P transaction service 830 represents a microservice that causes or instructs instant ACH transfers to be performed by a first financial institution 850a to move money electronically from an account of a sender (e.g., sender 801) maintained by the first financial institution 850a to an account of a recipient (e.g., recipient 802) maintained by the same or a different financial institution (e.g., one of financial institutions 850b-n). The transaction database 835 may store, among other things, transaction details and associated reference identifiers (IDs) associated with in-process, pending, or completed P2P transfers.

As noted above, financial institutions make use of a payment system or network (e.g., ACH network 840, which may be analogous to ACH network 740) to perform ACH transfers. The P2P transaction provider 860 may implement a thin wrapper over ACH transactions to perform instant ACH transactions based on a mapping of phone numbers and/or email addresses to corresponding account numbers of financial accounts (e.g., bank accounts). In this manner, the P2P transfer provider 860 may facilitate initiation of instant ACH transactions (e.g., via a mobile app) without the sender or payor having to have knowledge of the account number of the recipient or payee and instead allow instant ACH transactions to be initiated based on a phone number or an email address (that has previously been registered with the P2P payment system and associated with a particular financial account) of the recipient or payee.

The P2P transaction service 830 may be utilized directly by the sender to electronically transfer funds from their account held by financial institution 850a to an account of the recipient held at the same or a different financial institution (e.g., one of financial institutions 850b-n). For example, the sender may initiate a P2P transfer via a financial application (e.g., a mobile application, a web-based application, or a desktop application) provided by the financial institution 850a to its customers or provided by the P2P transaction provider 860. A non-limiting example of the P2P transaction service 830 is described further below with reference to FIG. 9.

In the context of the present example, the P2P transaction service 830 is assumed to be accessible by sender 801 through the use of a financial application (not shown) installed on, running within a web browser (not shown) of, or otherwise in communication with a sender computer system 811 (e.g., a smartphone, a laptop computer, a tablet computer, a desktop computer, etc.). Although the ACH network 840 through which ACH transfers are performed are generally considered to be secure, fraud and/or mistake may result in loss by the sender of the funds associated with a P2P transfer due to the speed at which they are settled.

According to various embodiments described herein, the transaction verification service 820 (e.g., a separate microservice deployed within the private cloud 810) may be invoked by the P2P transaction service 830 to request performance of pre-transaction verification of transaction details associated with a given P2P transfer and authentication of the recipient by the transaction verification service 820 before initiating the given P2P transfer (e.g., before directing the financial institution 850a to initiate an instant ACH transfer via the ACH network 840). Advantageously, use of the transaction verification service 820 may prevent loss by the sender of the funds associated with a P2P transfer by identifying potential mistakes in the transaction details and/or by identifying potential fraud. The transaction verification service 820 may be offered by the P2P transaction provider 860 as an additional (paid or free) service to provide its customers with peace of mind that the funds associated with a given P2P transfer are of the proper amount, will be delivered to the correct account, and the account is owned or managed by an authenticated individual. In one embodiment, the transaction verification service 820 represents functionality implemented by a third-party and which may expose one or more third-party APIs (e.g., REST APIs) for use by the P2P transfer service 830. Alternatively, the transaction verification service 820 may represent functionality implemented by information technology (IT) professionals associated with the P2P transaction provider 860.

As described further below, similar to transaction verification service 130 and 230 of FIGS. 1 and 2, the transaction verification service 820 may be responsible for one or both of verifying the transaction details (e.g., the name of the recipient, contact details for the recipient, an amount of funds to be transferred from the account of the sender to the account of the recipient, and a shared secret in possession of both of the sender and the recipient) associated with the P2P transfer and authenticating the recipient.

### Example ACH or P2P Transfer Service

FIG. 9 is a block diagram illustrating an example of an ACH or P2P transfer service 930 in accordance with an embodiment of the present disclosure. ACH or P2P transfer service 930 represents a non-limiting example of ACH transfer service 730 of FIG. 7 or P2P transaction service 830 of FIG. 8. In the context of the present example, ACH or P2P transfer service 930 is shown including a transaction details collection component 931, a transaction details retrieval component 932, and a verification status component 933.

The transaction details collection component 931 may represent a module or API endpoint (e.g., a REST API method) through which sender-provided transaction details (e.g., transaction details 934) relating to an electronic transfer (in this case, an ACH transfer or a P2P transfer) input by or on behalf of the sender (e.g., sender 701 or 801) may be received by the ACH transfer service 730 or the P2P transaction service 830. After receiving the transaction details 934, the transaction details collection component 931 may further be responsible for persisting the transaction details 934 to a transaction database 935 (which may be analogous to transaction database 735 or 835), receiving a reference identifier (ID) 936 from the transaction database 935 that corresponds to the persisted transaction details 934 (and the ACH transfer or P2P transfer at issue), and requesting a transaction verification service 920 (which may be analogous to transaction verification service 720 or 820) to perform pre-transaction verification and authentication to enhance the security of the ACH transfer or the P2P transfer. Depending on the particular implementation, the reference ID may be the bank transfer reference number (or transaction ID) or P2P transaction provider reference number created for the in-process ACH transfer or P2P transfer or may be a separate ID associated with the in-process ACH transfer or P2P transfer.

The transaction details retrieval component 932 may represent a module or API endpoint (e.g., a REST API method) exposed for use by the transaction verification service 920 to retrieve transaction details 934 for a given reference ID 936. Based on the given reference ID 936, the corresponding transaction details 934 may be retrieved from the transaction database 935 on behalf of the transaction verification service 920 and returned to the transaction verification service 920. As above, in this manner, the information security principle of least privilege (e.g., restricting access of computing processes to only those resources absolutely required to perform legitimate functions) is enforced. For example, to the extent the transaction verification service 920 represents functionality implemented by a third-party, security and integrity of the transaction database 935 is maintained by limiting access to the transaction verification service 920 to only transaction details 934 corresponding to a reference ID 936 of an ACH transfer or P2P transfer for which the ACH transfer service 730 or P2P transaction service 830 has expressly requested pre-transaction verification and authorization to be performed by the transaction verification service 920.

The verification status component 933 may represent a module or API endpoint (e.g., a REST API method) exposed for use by the transaction verification service 920 to communicate the result of the pre-transaction verification and authentication performed by the transaction verification service 920. In the context of the present example, the transaction verification service 920 provides a reference ID and status 937 to the verification status component 933 to indicate either an affirmative verification and authentication result for a given reference ID or a negative verification and authentication result for the given reference ID. The verification status component 933 may be responsible for updating the status of the electronic fund transfer (initially, marked as pending or in-process, for example) to “verified,” “verified and authenticated,” or the like. As described above with reference to pre-transaction verification of a wire transfer, an affirmative verification and authentication result emitted by the transaction verification service 920 may be used to confirm to the ACH transfer service 730 or the P2P transaction service 830 that the sender-provided transaction details match those confirmed by the recipient (e.g., recipient 702 or 802), for example, via interactions with the recipient through a recipient computer system 712 or 812 (e.g., a smartphone, a laptop computer, a tablet computer, a desktop computer, etc.) and that the recipient has also been authenticated by one or more of various means. In contrast, a negative verification and authentication result may be used by the transaction verification service 920 to inform the ACH transfer service 730 or the P2P transaction service 830 that the sender-provided transaction details do not match those confirmed by the recipient (e.g., recipient 702 or 802) or that the recipient could not be authenticated by one or more of various means. If and only if an affirmative verification and authentication result is received from the transaction verification service 920, the verification status component 933 may further be responsible for causing the ACH transfer or the P2P transfer corresponding to the reference ID to be performed, for example, by sending a transaction request 937 that includes an appropriate subset of the transaction details 934 to the ACH network 740 or the appropriate financial institution (e.g., financial institution 850a). For example, the verification status component 933 may make use of the transaction details retrieval component 932 to retrieve the transaction details 934 corresponding to the reference ID 936 from the transaction database 935. Alternatively, the verification status component 933 may directly query the transaction database 935 for the transaction details 934 corresponding to the reference ID 936.

While in the context of the present example, it is assumed the transaction database 935 assigns a reference ID to each individual ACH or P2P transfer, in other examples the transaction information collection module 931 or some other component of the ACH transfer service 730 or P2P transfer service 830 may assign the reference IDs.

While in the context of the present example, it is assumed the verification status component 933 causes a given ACH transfer or P2P transfer to be initiated after receiving an affirmative verification and authentication result from the transaction verification service 920, in other examples, another component of the ACH transfer service 730 or the P2P transaction service 830 may perform this function.

While in the context of the present example, access to the transaction database 935 is described as being limited to components of the ACH or P2P transfer service 930 (e.g., transaction details collection components 931, transaction details retrieval component 932, and verification status component 933), in alternative embodiments, given the existence of fewer regulatory compliance issues for ACH and P2P transfers, it is to be noted the transaction verification service 920 (as shown by the dashed lines in FIGS. 7 and 8) may establish a direct connection with the transaction database 935 rather than interacting with the transaction database 935 indirectly via the ACH or P2P transfer service 930. Depending on the particular implementation, transaction verification service 920 may have a similar (in the case of an insulated or protected transaction database 935) or more simplified architecture (e.g., in scenarios in which direct communication is allowed between the ACH or P2P transfer service 930 and the transaction database 935) to that described above with reference to FIG. 3.

### Example Payment Application Interface

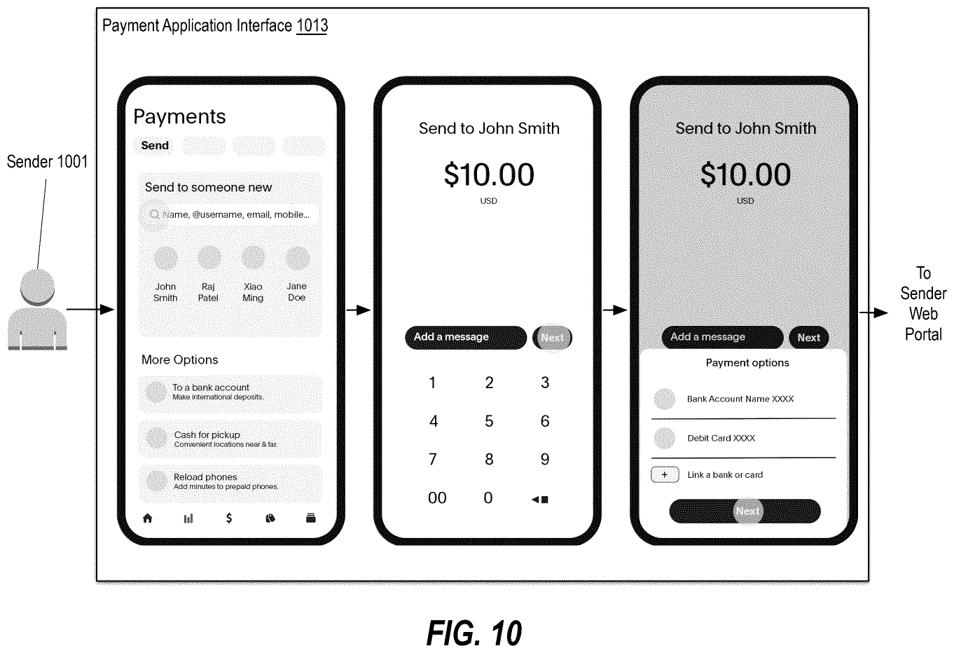

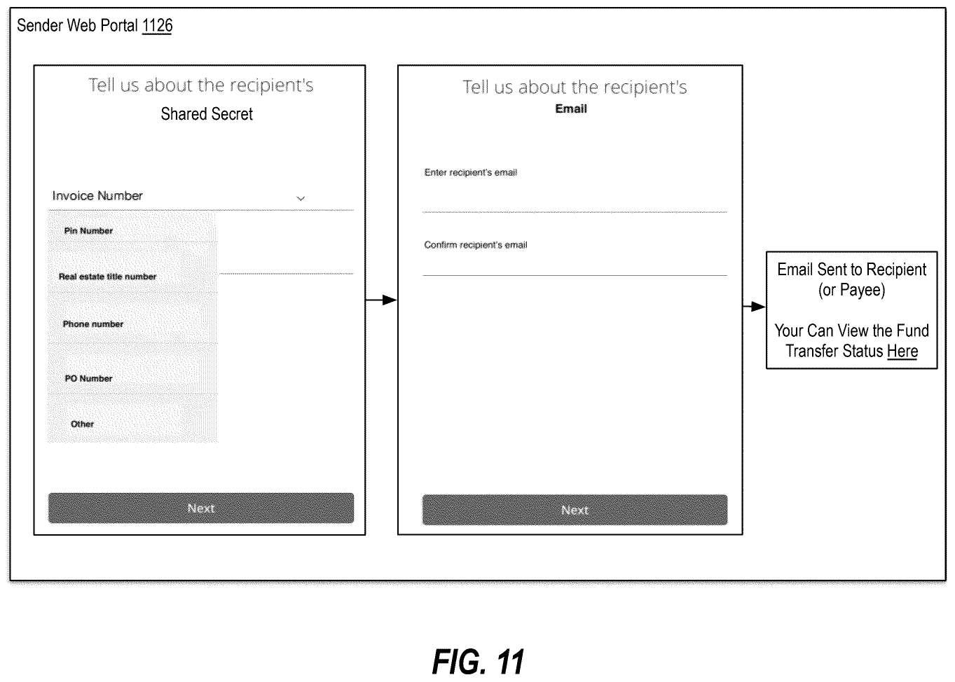

FIG. 10 is a block diagram illustrating an example of a payment application interface 1013 in accordance with an embodiment of the present disclosure. In the context of the present example, a mobile application of a P2P transaction provider (e.g., P2P transaction provider 860) is shown presenting various interface screens, for example, prompting a sender (e.g., sender 801) for information regarding to whom (e.g., recipient 802) a P2P transfer is to be directed and an amount of the P2P transfer. According to one embodiment, prior to initiating the P2P transfer, the mobile application may direct the sender to a sender web portal (e.g., a web page that presents one or more online forms to the sender, prompting the sender to input the shared secret in possession of both the sender and the recipient for verification of the P2P transfer). A non-limiting an example of interactions between a sender web portal and a sender and a recipient of a P2P transaction is described further below with reference to FIG. 11.

### Example Sender Web Portal Interactions

FIG. 11 is a block diagram illustrating an example of interactions by a sender web portal 1126 with a sender (e.g., sender 701 or 801) and a recipient (e.g., recipient 702 or 802) of a P2P transaction in accordance with an embodiment of the present disclosure. According to one embodiment, prior to performance of a P2P transaction, for example, initiated via a financial application (e.g., a mobile application, a web-based application, or a desktop application) of a financial institution or via a financial application (e.g., a mobile application, a web-based application, or a desktop application) of a P2P transaction provider (e.g., P2P transaction provider 860), the sender may be directed (e.g., by transaction verification service 720 or 820) to the sender web portal 1126.

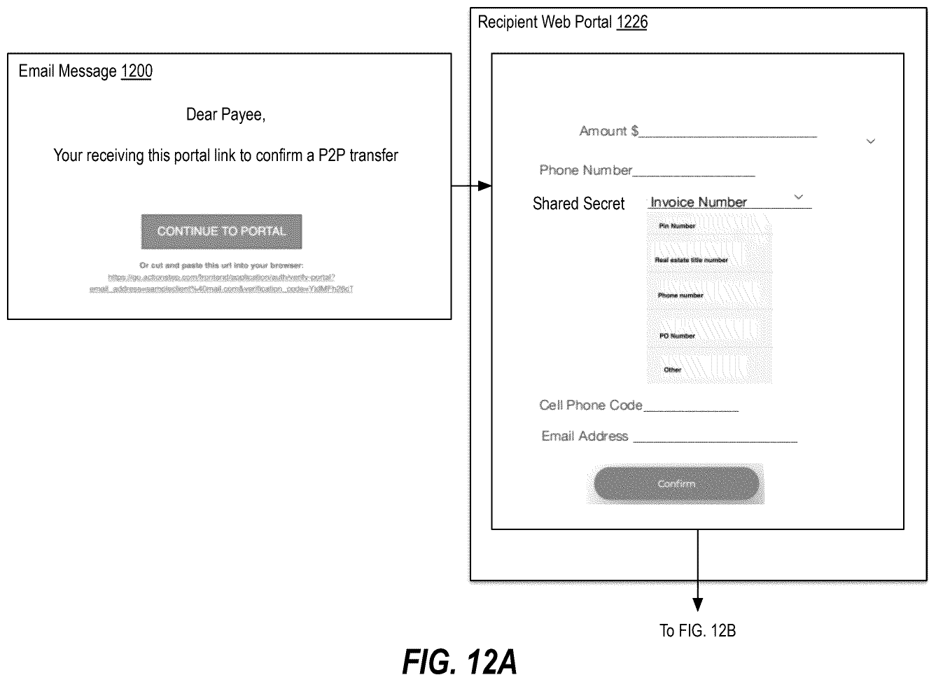

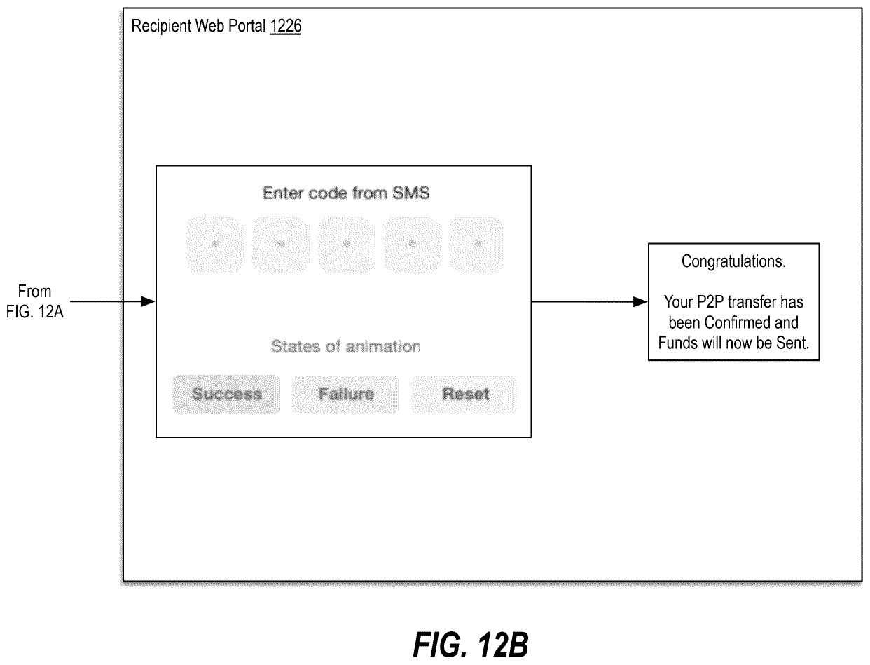

In the context of the present example, the sender web portal 1126 prompts the sender to input information regarding the shared secret and an electronic address (e.g., an email address or a mobile phone number) through which the recipient may receive electronic communications (e.g., email messages or SMS messages). As noted above, the shared secret may represent a piece of data or information that was previously agreed by the parties of the P2P transfer to be used to verify transaction details associated with the P2P transfer. For example, by convention, the parties may agree during a prior oral or written communication exchanged between the parties that a P2P transfer made after issuance of a given invoice by the recipient to the sender will be verified by both parties using the invoice number of the given invoice as the shared secret. Other non-limiting examples of a shared secret include a PIN, a real estate title number, a phone number, a PO number, and the like. As depicted in FIG. 11, the type of shared secret may be selected from a predetermined or configurable list from a drop down list and input via a corresponding text entry field (not shown). In addition, in FIG. 11, the sender is prompted to input an email address of the recipient. Upon completion of the data entry via the sender web portal 1126, the recipient may be sent an email message, for example, containing a verification link directing the recipient to a recipient web portal and the sender may be notified regarding transmission of the email message. A non-limiting an example of interactions with a recipient of a P2P transaction is described further below with reference to FIGS. 12A-B. The sender may also be provided with a link through which they can monitor the status of the P2P transfer.

While in the context of the present example, the sender web portal 1126 is described as being used in connection with performing pre-verification processing for a P2P transfer, it is to be appreciated the sender web portal 1126 (or the like) may also be used in connection with performing pre-verification processing for an ACH transfer, a wire transfer, and/or a cryptocurrency transfer.

### Example Sender Web Portal Interactions

FIGS. 12A-B are block diagrams illustrating an example of interactions with a recipient (e.g., recipient 702 or 802) of a P2P transaction in accordance with an embodiment of the present disclosure. As depicted in FIG. 12A, the recipient (or payee) may be informed via an email message 1200 (e.g., caused to be delivered to the recipient by a transaction verification service (e.g., transaction verification service 720 or 820)) that they are receiving a portal link to confirm a P2P transfer. The email message 1200 may also prompt the recipient to proceed to a recipient web portal 1226. After navigating to the recipient web portal 1226, the recipient may be prompted for transaction details associated with the P2P transaction, including, among other things, one or more of an amount of the P2P transaction, one or more of the recipient's phone number(s), and information regarding the shared secret. After completing entry of the requested transaction details, as shown in FIG. 12B, the recipient may further be prompted to confirm an OTP sent to the recipient via an SMS message directed to the recipient's mobile phone number. In this example, upon successfully confirming the OTP, the P2P transfer may be performed and the recipient may be informed that the funds are now being sent.

While in the context of the present example, the recipient web portal 1226 is described as being used in connection with performing pre-verification processing for a P2P transfer, it is to be appreciated the recipient web portal 1226 (or the like) may also be used in connection with performing pre-verification processing for an ACH transfer, a wire transfer, and/or a cryptocurrency transfer.

### Example Operational Environment for Pre-Transaction Verification of Cryptocurrency Transfers

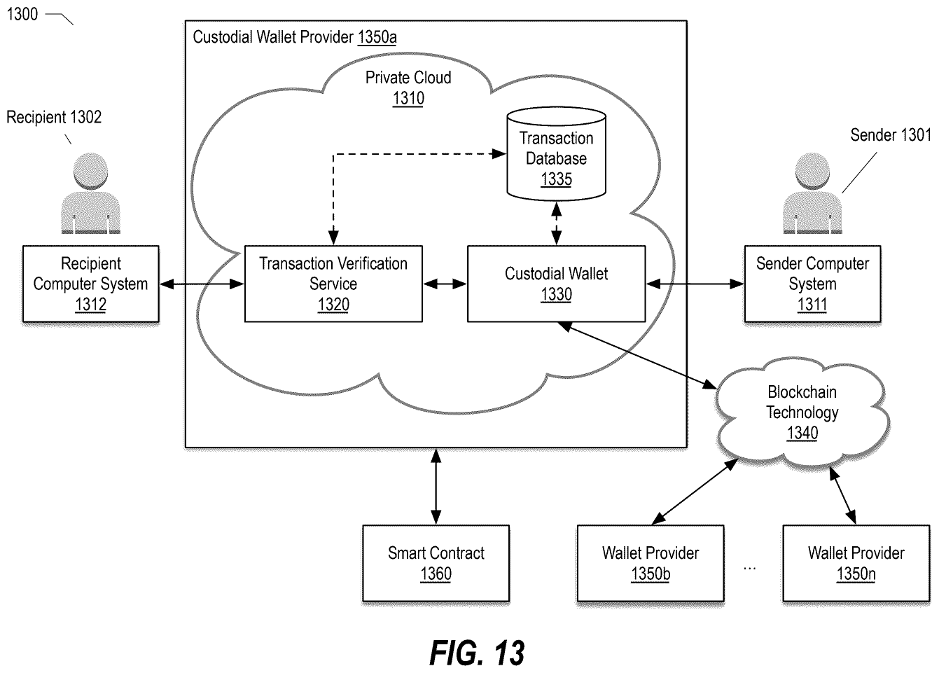

FIG. 13 is a high-level block diagram illustrating a transaction verification service implemented within a custodial wallet provider private cloud in accordance with yet another embodiment of the present disclosure. In the context of the present example, a private cloud 1310 of an electronic transfer service provider (e.g., custodial wallet provider 1350a) is shown including a custodial wallet 1330, a transaction database 1335, and a transaction verification service 1320. The custodial wallet provider 1350a may represent a cloud-based service that provides one or both of custodial wallet services and cryptocurrency exchange services to facilitate the trading (e.g., buying and/or selling) of cryptocurrencies. The private cloud 1310 may represent cloud infrastructure (e.g., in the form of a datacenter, a virtual private cloud within a public cloud, or the like) that is provisioned for exclusive use by the custodial wallet provider 1350a. The private cloud 1310 may be owned, managed, and operated by the custodial wallet provider 1350a, a third party, or some combination of them, and may exist on or off premises.

The custodial wallet 1330 represents a digital wallet that maintains private keys for and allows a user (e.g., sender 1310) to access their cryptocurrency. In one embodiment the custodial wallet 1330 represents a microservice that causes or instructs cryptocurrency transfers to be performed to another cryptocurrency wallet (not shown) of a recipient 1302 that may be associated with the same or a different wallet provider (e.g., one of wallet providers 1350b-n). In one embodiment, the cryptocurrency wallet of the recipient 1302 may be either a custodial or a non-custodial wallet. While in the context of wire transfers, ACH transfers, and P2P transfers, account numbers and routing numbers define the source and destination of the transfers, in the context of cryptocurrency transfers, wallet addresses (e.g., the public keys associated with the wallets) are used. The transaction database 1335 may store, among other things, transaction details and associated reference identifiers (IDs) associated with in-process, pending, or completed cryptocurrency transfers.

Wallet providers 1350a-n use blockchain technology 1340 to perform cryptocurrency transfers. Data regarding cryptocurrency transfers are recorded on a blockchain (not shown), which is a decentralized, digitally distributed, public ledger.

The custodial wallet 1330 may be utilized by the sender to perform an electronic transfer of assets (a cryptocurrency transfer) from the custodial wallet 1330 to a cryptocurrency wallet (not shown) of the recipient associated with the same or a different wallet provider (e.g., one of wallet providers 1350b-n). For example, the sender may initiate a cryptocurrency transfer via an application (e.g., a mobile application, a web-based application, or a desktop application) provided by or made available for download by the custodial wallet provider 1350a to its customers.

In the context of the present example, the custodial wallet 1330 is assumed to be accessible by sender 1301 through the use of an application (not shown) installed on, running within a web browser (not shown) of, or otherwise in communication with a sender computer system 1311 (e.g., a smartphone, a laptop computer, a tablet computer, a desktop computer, etc.). Although the blockchain technology 1340 through which cryptocurrency transfers are performed are generally considered to be secure, fraud and/or mistake may result in loss by the sender of the funds associated with a cryptocurrency transfer due to the irreversible nature of cryptocurrency protocols. For example, if the sender 1301 directs a cryptocurrency transfer to an incorrect wrong wallet address, the transaction will still go through, but the cryptocurrency will be sent to an unintended recipient and will no longer be accessible to the sender 1301 unless the unintended recipient agrees to return the cryptocurrency to the sender 1301.

According to various embodiments described herein, the transaction verification service 1320 (e.g., a separate microservice deployed within the private cloud 1310) may be invoked by the custodial wallet 1330 to request performance of pre-transaction verification of transaction details associated with a given cryptocurrency transfer and authentication of the recipient by the transaction verification service 1320 before initiating the given cryptocurrency transfer (e.g., before directing the blockchain technology 1340 to perform the cryptocurrency transfer. Advantageously, use of the transaction verification service 1320 may prevent loss by the sender of the cryptocurrency associated with a cryptocurrency transfer by identifying potential mistakes in the transaction details and/or by identifying potential fraud. The transaction verification service 1320 may be offered by the custodial wallet provider 1350a as an additional (paid or free) service to provide its customers with peace of mind that the cryptocurrency associated with a given cryptocurrency transfer is of the proper amount, will be delivered to the correct wallet address of the recipient 1302, and the destination wallet address is owned or managed by an authenticated individual. In one embodiment, the transaction verification service 1320 represents functionality implemented by a third-party and which may expose one or more third-party APIs (e.g., REST APIs) for use by the custodial wallet 1330. Alternatively, the transaction verification service 1320 may represent functionality implemented by information technology (IT) professionals associated with the custodial wallet provider 1330a.

Similar to transaction verification service 130 and 230 of FIGS. 1 and 2, the transaction verification service 1320 may be responsible for one or both of verifying the transaction details associated with the cryptocurrency transfer and authenticating the recipient. As the transaction verification service 1320 may generally have functionality and architecture similar to that described with reference to FIG. 3 and may utilize web portals similar to those described with reference to FIGS. 11 and FIGS. 12A-B, for sake of brevity, those details will not be repeated again as the only substantive differences relate to the (optional) use of a smart contract 1360 and the specific transaction details to be verified, which in the case of a cryptocurrency transfer may include one or more of the name of the recipient, contact details for the recipient, a type of cryptocurrency (e.g., Bitcoin, Ethereum, etc.) at issue, an amount of the cryptocurrency to be transferred from the custodial wallet 1330 of the sender to the cryptocurrency wallet of the recipient, and a shared secret in possession of both of the sender and the recipient.

Turning now to the smart contract 1360, it may be created within a blockchain platform (e.g., Polygon, formerly Matic Network, or the like) by the custodial wallet provider 1350a and used to provide transparency regarding cryptocurrency transfers for which pre-transaction verification processing was performed by the transaction verification service 1320. According to one embodiment, after performing processing analogous to that described above with reference to FIGS. 5 and 6 and prior to returning the verification status (e.g., also referred to herein as the verification and authentication result) to the custodial wallet 1330, the transaction verification service 1320, may, among other things, persist the final verification status (e.g., successful verification, failed verification, etc.) determined by the transaction verification service 1320 for a given cryptocurrency transfer. For example, since Ethereum has scaling problems, the transaction verification service 1320 may store verification records onto a sidechain (running in parallel with the Ethereum blockchain) so as to improve transaction speeds and lower costs. In this manner, a permanent record may be maintained regarding all cryptocurrency transfers for which pre-transaction verification processing was performed by or on behalf of the custodial wallet provider 1350a and interested parties may view verification details for a particular cryptocurrency transfer for which they would like to learn more.

Non-limiting examples of methods that may be exposed by the smart contract include one or more of the following:
storeVerficationDetails( )—Allows the owner (e.g., the custodial wallet provider 1350a) of the smart contract 1360 to securely document details about a given cryptocurrency transfer, for example, by creating and storing on a side chain a digital record containing information regarding the verification status of the given cryptocurrency transfer, including, among other things, information regarding the sender, information regarding the recipient, and unique identifiers. According to one embodiment, input parameters to this method may include (i) a payment ID of the cryptocurrency transfer for which verification was requested by the transaction verification service 1320, (ii) the verification status (e.g., success or failure), the cryptocurrency wallet address of the sender, the cryptocurrency wallet address of the recipient, (iii) the transaction hash associated with the verification, and (iv) other additional details about the cryptocurrency transfer.
changeOwner( )—Allows the current owner to transfer ownership of the smart contract 1360, for example, from an administrative wallet maintained by the custodial wallet provider 1350a to a new address. According to one embodiment, input parameters to this method may include the wallet address to which ownership is to be transferred.
getVerificationDetails( )—Allows anyone to look up and review the verification details stored (by the storeVerficationDetails( ) method) for a given cryptocurrency transfer. According to one embodiment, input parameters to this method include the unique ID (e.g., a payment ID) for the cryptocurrency transfer at issue.
getOwner( )—Allows anyone to inquire about the current owner of the smart contract 1360.

### Example Computer System

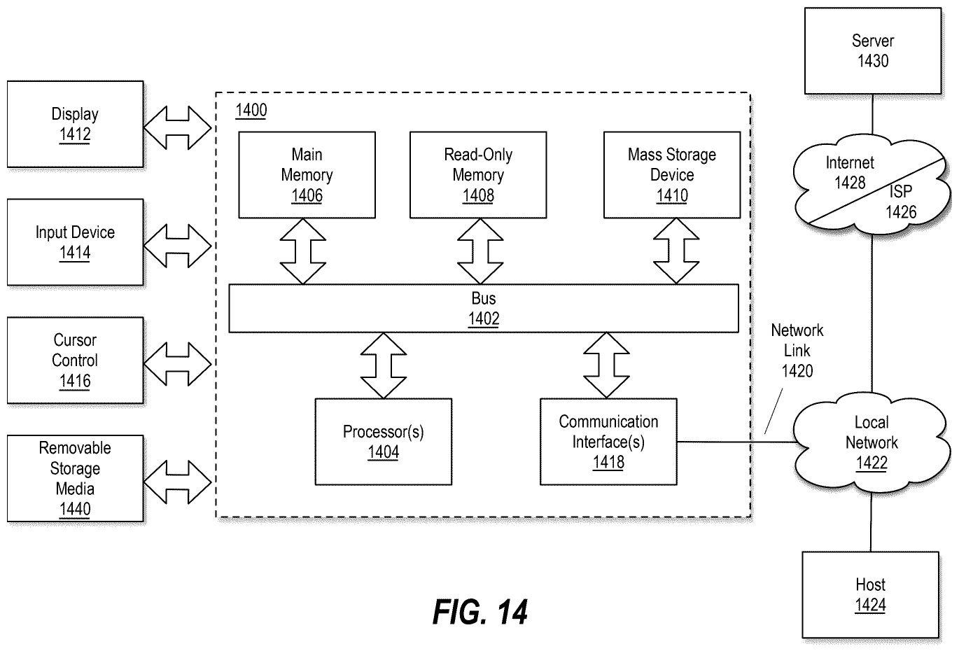

FIG. 14 is an example of a computer system 1400 with which some embodiments may be utilized. One or more components of computer system 1400 may represent all or some subset of one or more computer systems on which various of the services described herein (e.g., transaction verification service 120, 720, 820 and 1320, wire transfer service 130, ACH transfer service 730, P2P transaction service 830, and custodial wallet 1330) may run. Similarly, one or more components of computer system 1400 may represent all or some subset of a computer system (e.g., sender computer system 111, 711, 811, or 1311) utilized by a sender (e.g., sender 101, 701, 801, or 1301) or a computer system (e.g., recipient computer system 112, 712, 812, or 1312) used by a recipient (e.g., recipient 102, 702, 802, or 1302). Notably, components of computer system 1400 described herein are meant only to exemplify various possibilities. In no way should example computer system 1400 limit the scope of the present disclosure. In the context of the present example, computer system 1400 includes a bus 1402 or other communication mechanism for communicating information, and one or more processing resources (e.g., one or more hardware processors 1404) coupled with bus 1402 for processing information. The processing resource may be, for example, one or more general-purpose microprocessors or a system on a chip (SoC) integrated circuit.

Computer system 1400 also includes a main memory 1406, such as a random-access memory (RAM) or other dynamic storage device, coupled to bus 1402 for storing information and instructions to be executed by processor(s) 1404. Main memory 1406 also may be used for storing temporary variables or other intermediate information during execution of instructions to be executed by processor(s) 1404. Such instructions, when stored in non-transitory storage media accessible to processor(s) 1404, render computer system 1400 into a special-purpose machine that is customized to perform the operations specified in the instructions.

Computer system 1400 further includes a read only memory (ROM) 1408 or other static storage device coupled to bus 1402 for storing static information and instructions for processor(s) 1404. A storage device 1410, e.g., a magnetic disk, optical disk or flash disk (made of flash memory chips), is provided and coupled to bus 1402 for storing information and instructions.

Computer system 1400 may be coupled via bus 1402 to a display 1412, e.g., a cathode ray tube (CRT), Liquid Crystal Display (LCD), Organic Light-Emitting Diode Display (OLED), Digital Light Processing Display (DLP) or the like, for displaying information to a computer user. An input device 1414, including alphanumeric and other keys, is coupled to bus 1402 for communicating information and command selections to processor(s) 1404. Another type of user input device is cursor control 1416, such as a mouse, a trackball, a trackpad, or cursor direction keys for communicating direction information and command selections to processor(s) 1404 and for controlling cursor movement on display 1412. This input device typically has two degrees of freedom in two axes, a first axis (e.g., x) and a second axis (e.g., y), that allows the device to specify positions in a plane.

Removable storage media 1440 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 1400 may implement the techniques described herein using customized hard-wired logic, one or more ASICs or FPGAs, firmware or program logic which in combination with the computer system causes or programs computer system 1400 to be a special-purpose machine. According to one embodiment, the techniques herein are performed by computer system 1400 in response to processor(s) 1404 executing one or more sequences of one or more instructions contained in main memory 1406. Such instructions may be read into main memory 1406 from another storage medium, such as storage device 1410. Execution of the sequences of instructions contained in main memory 1406 causes processor(s) 1404 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 1410. Volatile media includes dynamic memory, such as main memory 1406. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1402. Transmission media can also take the form of acoustic or light waves, such as those generated during radio-wave and infra-red data communications.

Various forms of media may be involved in carrying one or more sequences of one or more instructions to processor(s) 1404 for execution. For example, the instructions may initially be carried on a magnetic disk or solid-state drive of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor(s) 1404 retrieve and execute the instructions. The instructions received by main memory 1406 may optionally be stored on storage device 1410 either before or after execution by processor(s) 1404.

Computer system 1400 also includes interface circuitry 1418 coupled to bus 1402. The interface circuitry 1418 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. As such, interface 1418 may couple the processing resource in communication with one or more discrete accelerators (e.g., one or more XPUs).

Interface 1418 may also provide a two-way data communication coupling to a network link 1420 that is connected to a local network 1422. For example, interface 1418 may be an integrated services digital network (ISDN) card, cable modem, satellite modem, or a modem to provide a data communication connection to a corresponding type of telephone line. As another example, interface 1418 may be a local area network (LAN) card to provide a data communication connection to a compatible LAN. Wireless links may also be implemented. In any such implementation, interface 1418 may send and receive electrical, electromagnetic or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the worldwide packet data communication network now commonly referred to as the “Internet” 1428. Local network 1422 and Internet 1428 both use electrical, electromagnetic or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418. The received code may be executed by processor(s) 1404 as it is received, or stored in storage device 1410, or other non-volatile storage for later execution.

While many of the methods may be described herein in a basic form, it is to be noted that processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments require more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A computer-implemented method comprising:
receiving, by a first financial institution having an account of a sender, a request to initiate a transfer of funds from the account of the sender to an account of a recipient associated with a second financial institution;
receiving, by or on behalf of the sender, transaction details, including an amount of funds to be transferred from the account of the sender to the account of the recipient, a financial institution identifier of the second financial institution, and an account number of the account of the recipient;
verifying the transaction details and authenticating the recipient by:
receiving, by or on behalf of the sender, at a web portal (i) an electronic address through which the recipient may receive electronic communications and (ii) a shared secret in possession of both the sender and the recipient;
causing an electronic communication, including a link to a recipient verification portal, to be sent to the recipient via the electronic address;
responsive to the recipient navigating to the recipient verification portal, causing the recipient to be prompted for the transaction details and the shared secret;
determining a verification and authentication result by comparing (i) the transaction details received by or on behalf of the sender to the transaction details received from the recipient and (ii) the shared secret received by or on behalf of the sender to the shared secret received from the recipient; and
only after an affirmative verification and authentication result has been determined, permitting the transfer of funds to proceed.

2. The computer-implemented method of claim 1, wherein the transfer comprises a wire transfer.

3. The computer-implemented method of claim 2, wherein said verifying is performed by a transaction verification microservice deployed within a private cloud of the first financial institution that is in communication with a wire transfer service of the first financial institution deployed within the private cloud.

4. The computer-implemented method of claim 2, wherein said verifying is performed by a wire transfer service of the first financial institution that is in direct or indirect communication with a Society for Worldwide Interbank Financial Transactions (SWIFT) network or a Fedwire payment system.

5. The computer-implemented method of claim 2, wherein the electronic address comprises a phone number and wherein the electronic communication comprises a Short Message Service (SMS) message directed to the phone number.

6. The computer-implemented method of claim 2, wherein the electronic address comprises an electronic mail (email) address and wherein the electronic communication comprises an email message directed to the email address.

7. The computer-implemented method of claim 2, wherein said authenticating the recipient further comprises:
prior to said determining a verification and authentication result, causing an authentication code to be delivered to the recipient via a separate electronic communication; and
performing said determining after the recipient correctly provides the authentication code via the recipient verification portal.

8. The computer-implemented method of claim 2, wherein the request to initiate the transfer and the transaction details are received by or on behalf of the sender via an application or online portal associated with the first financial institution.

9. The computer-implemented method of claim 2, wherein the request to initiate the transfer and the transaction details are received from an employee of the first financial institution via an application or online portal associated with the first financial institution.

10. The computer-implemented method of claim 1, wherein the transfer comprises an Automated Clearing House (ACH) transfer and wherein said verifying is performed by a transaction verification microservice deployed within a private cloud of the first financial institution that is in communication with an ACH network.

11. The computer-implemented method of claim 10, wherein the electronic address comprises a phone number and wherein the electronic communication comprises a Short Message Service (SMS) message directed to the phone number.

12. The computer-implemented method of claim 10, wherein the electronic address comprises an electronic mail (email) address and wherein the electronic communication comprises an email message directed to the email address.

13. The computer-implemented method of claim 10, wherein said authenticating the recipient further comprises:
prior to said determining a verification and authentication result, causing an authentication code to be delivered to the recipient via a separate electronic communication; and
performing said determining after the recipient correctly provides the authentication code via the recipient verification portal.

14. The computer-implemented method of claim 10, wherein the request to initiate the transfer and the transaction details are received by or on behalf of the sender via an application or online portal associated with the first financial institution.

15. The computer-implemented method of claim 10, wherein the request to initiate the transfer and the transaction details are received from an employee of the first financial institution via an application or online portal associated with the first financial institution.

16. A computer-implemented method comprising:
receiving, by a peer-to-peer (P2P) transaction provider, a request to initiate a P2P transfer of funds from an account of a sender associated with a first financial institution to an account of a recipient associated with the first financial institution or a second financial institution;
receiving, by the P2P transaction provider from the sender, transaction details, including an amount of funds to be transferred from the account of the sender to the account of the recipient and an electronic mail (email) address of the recipient or a mobile phone number of the recipient that is associated with the account of the recipient;
verifying the transaction details and authenticating the recipient by:
receiving, at a web portal, a shared secret in possession of both the sender and the recipient;
causing an electronic communication, including a link to a recipient verification portal, to be sent to the recipient via the email address or the mobile phone number;
responsive to the recipient navigating to the recipient verification portal, causing the recipient to be prompted for the transaction details and the shared secret;
determining a verification and authentication result by comparing (i) information entered by the recipient regarding the transaction details to the transaction details received from the sender and (ii) the shared secret received from the sender to the shared secret received from the recipient; and
only after an affirmative verification and authentication result has been determined, permitting the P2P transfer to proceed.

17. A computer-implemented method comprising:
receiving, by a custodial wallet provider, a request to initiate a cryptocurrency transfer from a custodial wallet of a sender to a wallet of a recipient associated with the custodial wallet provider or another wallet provider;
receiving, by the custodial wallet provider from the sender, transaction details, including an amount of cryptocurrency to be transferred from the custodial wallet of the sender to the wallet of the recipient;
verifying the transaction details and authenticating the recipient by:
receiving, at a web portal, (i) an electronic address through which the recipient may receive electronic communications and (ii) a shared secret in possession of both the sender and the recipient;
causing an electronic communication, including a link to a recipient verification portal, to be sent to the recipient via the email address or the mobile phone number;
responsive to the recipient navigating to the recipient verification portal, causing the recipient to be prompted for the transaction details and the shared secret;
determining a verification and authentication result by comparing (i) information entered by the recipient regarding the transaction details to the transaction details received from the sender and (ii) the shared secret received from the sender to the shared secret received from the recipient; and
only after an affirmative verification and authentication result has been determined, permitting the P2P transfer to proceed.
